(19) United States
(12) Patent Application Publication
(10) Pub. No.: US 2006/0149720 A1
(43) Pub. Date: Jul. 6, 2006

(54) System and method for retrieving information from citation-rich documents

(76) Inventor: Peter J. Dehlinger, Palo Alto, CA (US)

Correspondence Address: PERKINS COIE LLP, P.O. BOX 2168, MENLO PARK, CA, 94026, US

(21) Appl. No.: 11/321,369

(22) Filed: Dec. 28, 2005

Related U.S. Application Data
(60) Provisional application No. 60/640,740, filed on Dec. 30, 2004.
(60) Provisional application No. 60/685,724, filed on May 27, 2005.

(51) Int. Cl. G06F 17/30

(52) U.S. Cl. 707/3

(57) ABSTRACT

Disclosed are a computer-readable code, system and method for use in accessing information derivable from a collection of citation-rich documents, such as scientific articles, works of scholarship, appellate cases, legal documents, and the like. The system includes a database containing phrases that represent summary holdings, statements, or conclusions contained in said documents, and for each such phrase, a tag representing the citation associated with that statement in a document. The method involves searching the database to identify one or more phrases that correspond to a user-input statement of interest, accessing the database to link each of the one or more phrases so identified to an associated citation tag in the database, and presenting to the user, information related to the linked citation tag(s).

This application claims priority to U.S. Provisional Patent Application Nos. 60/640,740 filed Dec. 30, 2004 and 60/685,724 filed Mar. 25, 2005, both of which are incorporated in their entirety herein by reference.

### FIELD OF THE INVENTION

The present invention relates to a system and method for retrieving and managing information from citation rich documents and in a more general aspect, to an information or knowledge management system and method for processing, mining, retrieving, and distributing information contained in citation-rich documents. It also related to a knowledge management system based on a statements/citation or tagged phrase database format.

### BACKGROUND OF THE INVENTION

An important function of knowledge management (KM) for an organization such as a law firm or research organization is the management of the information created by the organization, typically in the form of written documents. For example, in a law firm, it is desirable to provide all professionals within the firm access to the documents created within the firm. The documents may be of interest as models for generating new documents, as models of how others have solved certain legal problems or made particular legal arguments, to identify professionals with expertise in a given area of the law, or to identify pertinent case citations.

A variety of tools for KM are available commercially, and several of these are designed specifically for processing and accessing information contained in written documents, including retrieving the documents themselves. These systems store document information in database form, allowing user retrieval of the documents by conventional key-word type searching of the overall document text. Because of the number of documents that are likely to be generated within a large organization, e.g., a law firm with 100-1,000 attorneys, the documents typically have to be pre-selected and then further pre-classified according to legal group or area, or by user or date, in order to retrieve efficiently. The requirement for pre-selection and/or pre-classification adds an overall burden to the document management and retrieval operations in a KM system. Even with pre-classification, a key-word search of the overall text may lack sufficient precision to provide a useful discriminator among a large number of similar documents.

It would therefore be desirable to provide an improved KM system for managing document information, and in particular, a system that allows for more efficient, accurate information management in stored documents, and in particular, citation-rich documents, that is, documents containing a plurality of bibliographic citations. Such a search system should have additional applications in KM, for example, as a database for citations, or for providing users with update citations, or for constructing legal arguments.

### SUMMARY OF THE INVENTION

In one aspect, the method includes a computer-assisted method for use in accessing information derivable from a collection of citation-rich documents, such as scientific articles, works of scholarship, legal appellate cases, legal documents, and the like. The method includes the steps of (a) accessing a database containing phrases that represent summary holdings, statements, or conclusions contained in the documents, and for each such phrase, a tag representing the citation associated with that statement in a document, (b) searching the database to identify one or more phrases that correspond to a user-input statement of interest, (c) accessing the database to link each of the one or more phrases identified in (b) to an associated citation tag in the database, and (d) presenting to the user, information related to the linked citation tag(s) from step (c).

For use in identifying one or more citations for a user-input statement of interest, the information presented to the user in step (d) may include (i) the one or more phrases identified in step (b) and (ii) for each phrase, the citation corresponding to the tag associated with that phrase. Where one or more of the citations in the database are associated with multiple phrases, the information presented in step (d) may further include, for each citation presented, phrases associated with that citation other than those identified in step (b).

In one general embodiment, the database includes a words-record table or index containing non-generic words in the phrases, and for each word in the table, a list of all phrases, by phrase identifier, that contain that word, and, in the same or in a separate table, a citation identifier associated with each phrase identifier. In this embodiment, step (b) includes, for each non-generic word in the word user-input statement, accessing the word-records table to identify all phrases in the documents containing that word, and determining the phrase(s) in the database having the highest word match ranking with the statement, and linking step (c) includes accessing a table in the database to determine the identifiers of the citations associated with the highest-ranking phrase(s).

Where the method is used for identifying one or more documents whose content is related to a user-input statement of interest, the database may includes a table linking each citation tag with one or more documents, and the information presented in step (d) includes information about the documents containing the one or more citations linked from step (c). The method for identifying one or more documents may further include repeating step (b)-(d) for each of one or more additional user-input statements of interest, and the information presented in step (d) at each iteration may include information about the documents that contain citations relating to the successive user-input statements. The method may further include, following step (d) in each iteration, accepting user input indicating a selection of one or more presented citations for that iteration.

In one embodiment of the document-search method, there is displayed along with the citations, the number of documents containing the previously selected and newly selected citations, where the iterations are continued until the number of documents containing the selected and identified citations is desirably small. The database used in the method may includes a matrix whose matrix values represent, for each pair of citation tags, a number related to the document affinity of the two citations of the pair. The method may further include step (e), having the operation of, after selecting one or more citations identified from more or more iterations of steps (b)-(d), (e1) accessing the matrix to identify citations that have a high affinity with the one or more selected citations, (e2) determining for each of the citations identified in (e1), the total number of documents containing one or more of the selected citations and one of the citations identified in (e1), (e3) displaying those citations identified from (e1) having the highest total number of documents determined from (e2), along with the document number so determined, and (e4) allowing the user to select one or more citations displayed in (e3).

For use in accessing data derivable from the citation-rich documents, the database may include one or more tables relating the citation tags to the data, and the information displayed in step (d) may includes the data of interest. The data may be related to, for example, document date, document author, citation author, citation date, and/or other citation tags related to the linked citation tag from step (c).

In another aspect, the invention includes computer-readable code for use with an electronic computer in accessing information derivable from a collection of citation-rich documents, by accessing a database containing phrases that represent summary holdings, statements, or conclusions contained in the documents, and for each such phrase, a tag representing the citation associated with that statement in a document. The code is operable, under the control of the computer, and by accessing the database, to perform the method steps above.

In still another aspect, the invention includes an information retrieval or management system for use in accessing information derivable from a collection of citation-rich documents. The system includes (1) a computer, (2) accessible by the computer, a database containing phrases that represent summary holdings, statements, or conclusions contained in the documents, and for each such phrase, a tag representing the citation associated with that statement in a document, (3) a user input device operatively connected to the computer, by which the user can input one or more statements of interest, (4) computer-readable code which operates on the computer to perform the method steps above, and (5) a display device operatively connected to the computer for presenting to the user, information produced in carrying out the method.

Also disclosed is a citation statements database for citation-rich documents, such as scientific articles, works of scholarship, appellate cases, legal documents and the like containing phrases that represent summary holdings or conclusions of references cited in the documents. The database includes (1) a words-record table or index containing non-generic words in the phrases, and for each word in the table, a list of all phrases, by phrase identifier, that contain that word, and, in the same or in a separate database table, (2) a phrase-identifier table of all phrase identifiers, and, for each phrase identifier in the table, the text of that phrase, and the tag identifier of the citation associated with that phrase in the documents, (3) a tag-identifier table of all citation tag identifiers, and for each tag identifier, a list of all documents containing the corresponding citation; and optionally, (4) a document-identifier table of all document identifiers, and for each such identifier, information relating to that document.

The database may also include a tag-affinity matrix whose matrix values represent, for each pair of citations in the database, the co-occurrences of the citations in the documents.

In still another aspect of the invention, the phrases harvested from a collection of citation-rich documents form a basis set of statements, that is, a group of statements that represent a large number of “knowledge statements” in a given field, such as a legal or scientific field. Each of these tagged phrases is used as a search query for non-citation statements in a collection of documents, which may include both citation-rich documents from which the statements are derived, and other non-citation documents. Each matched sentence or sentences retrieved in this manner is assigned a tag that may correspond to the original-phrase tag. The “derivative” set of tagged sentences found by identifying one or more document sentences with each original tagged phrase can be searched, mined, and managed in the same way that the original set of tagged phrases can be. In addition, the derivative tagged sentences may be linked, via the derivative tags, to the original tags, allowing information management functions “across” the two sets of tagged phrases.

These and other objects and features of the invention will become more fully apparent when the following detailed description of the invention is read in conjunction with the accompanying drawings.

### BRIEF DESCRIPTION OF THE DRAWINGS

FIG. 1 shows hardware and software components of the system of the invention;

FIG. 2 shows, in summary diagram form, the processing of citation-rich documents to form several of the database tables in the database of the invention;

FIGS. 3A-3E show representative table entries in a statement-ID table (3A), a word-records table (3B), a citation-ID table (3C), a document-ID table (3D), and a user-ID table (3E);

FIGS. 4A and 4B show in flow diagram form, operations in processing a citation-rich document to form the statement-ID table, document-ID table, and citation-ID table in the database of the invention (4A), and in assigning citation IDs (4B);

FIG. 5 is a flow diagram of steps used in generating a word-records table in the database of the invention;

FIG. 6 is a flow diagram of steps used in generating a co-occurrence matrix in the database of the invention;

FIG. 7 is a flow diagram of steps employed in matching a word query with a citation statement in the method of the invention;

FIG. 8 is a flow diagram of steps used in ranking top-ranked citations according to citation date and number of citation-containing documents;

FIG. 9 is a summary flow diagram of steps for retrieving a citation-rich document of interest, in accordance with various embodiments of the method of the invention;

FIG. 10 shows two groups of rows from a co-occurrence matrix, for identifying citations that are related to the selected citations represented by the rows;

FIG. 11 shows steps employed in the system for identifying citations related to two groups of citations;

FIG. 12 shows document vectors for two groups of selected citations, and the document vector for a test citation, for calculating the document occurrence of test citations, when combined with the selected citations;

FIG. 13 shows steps in the operation of the invention, in one embodiment, in identifying and reporting updated citations to a user;

FIGS. 14A-14E illustrate, in Venn diagram form, successive search queries used in retrieving a document in the system of the invention;

FIG. 15 shows the statement/citation database organization in the knowledge management (KM) system of the invention;

FIG. 16 shows a portion of an attorneys-citation matrix used in identifying attorneys with project-specific expertise, in the KM system of the invention;

FIG. 17 is a flow diagram of the operation of the system for generating a derivative set of tagged sentences; and

FIG. 18 shows a user interface for the system of the invention.

### DETAILED DESCRIPTION OF THE INVENTION

A. Definitions

A “phrase” refers to a summary of a holding or conclusion associated with a cited reference, or citation. The phrase is typically a complete (often short) sentence, and is followed by a bibliographic citation, which may be a footnote or author citation or case-name citation to a bibliographic listing of cited references or cases, or may be the actual citation itself. A “phrase” may also be referred to herein as a “statement.”

A “document” refers to a self-contained, written or printed work, such as an article, patent, agreement, legal brief, book, treatise or explanatory material, such as a brochure or guide, being composed of plural paragraphs or passages. A “citation-rich document” is one containing a plurality of cited references or citations, and associated phrases. For example, a reported court case typically contains many cited cases, where each cited case (citation) is accompanied by a holding or summary of that case (the statement of the case). Similarly, many types of legal documents prepared by lawyers, such as opinions, briefs, and legal memos, will contain a plurality of cited cases, along with the case holdings or summaries. A scientific or scholarly article will likewise contain a plurality of cited references, typically in footnote/bibliographic form, each preceded by or adjacent a phrase that summarizes the idea or conclusion of that cited reference.

A “search query” or “query statement” or “user-input query” or “statement” refers to a single sentence or sentences a sentence fragment or fragments or list of words and/or word groups that are descriptive of the content of a statement or text to be searched.

A “verb-root” word is a word or phrase that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language passage that are not descriptive of, or only non-specifically descriptive of, the subject matter of the passage. Examples include prepositions, conjunctions, pronouns, as well as certain nouns, verbs, adverbs, and adjectives that occur frequently in passages from many different fields. “Non-generic words” are those words in a passage remaining after generic words are removed.

A “document identifier” or “DID” identifies a particular digitally encoded or processed document in a database, in particular, a citation-rich document.

A “phrase identifier” or “PID” identifies a particular phrase, in particular, a phrase extracted from a citation-rich document and associated with one or more citations. Typically, each phrase extracted from a citation-rich document is assigned a separate identifier, so that identical phrases extracted from different documents are assigned different PIDs, although they may have the same citation identifier or tag.

A “citation identifier” or “citation tag” or “tag” or “CID” identifies a particular citation, e.g., case cite or bibliographic reference extracted from a citation-rich document. A citation identifier may be associated with one or more, often several, different phrase identifiers. Typically, a citation will be associated with about the same number of different phrases as there are documents in which that citation occurs.

A “database” refers to a database of records or tables containing information about documents and/or other document- or citation-related information. A database typically includes two or more tables, each containing locators by which information in one table can be used to access information in another table or tables.

A “tagged phrase” refers to a phrase extracted from a citation-rich document and its associated citation or tag. A “tagged sentence” refers to a sentence extracted from a document, and which has been assigned a tag based on a predetermined level of word match with a tagged phrase.

B. System Components

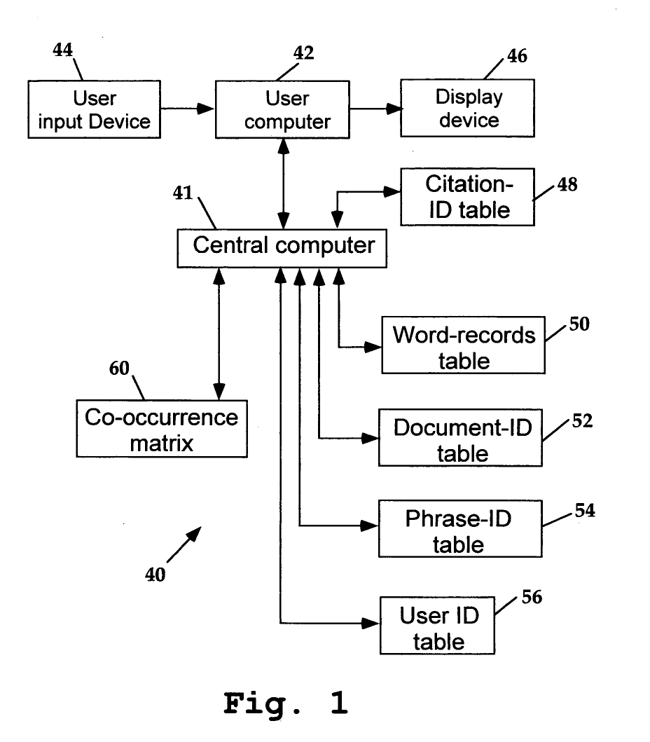

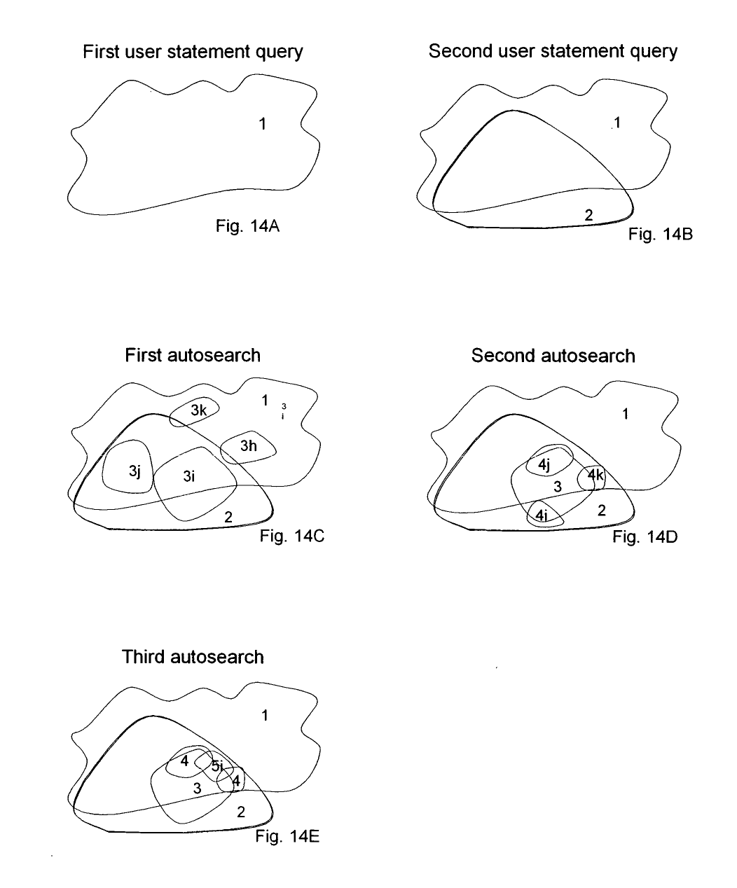

FIG. 1 shows the basic components of a system 40 for use in accessing information derivable from a collection of citation-rich documents, such as scientific articles, works of scholarship, legal appellate cases, legal documents, and the like. A computer or processor 42 in the system may be a stand-alone computer or a central computer or server that communicates with a user's personal computer. The computer has an input device 44, such as a keyboard, modem, and/or disc reader, by which the user can enter query or other information as will be described below. A display or monitor 46 displays the interface and program operation states and output. One exemplary interface is described below with respect to FIG. 15. Computer 42 in the system is typically one of many user terminal computers, each of which communicates with a central server or processor 41 on which the main program activity in the system takes place.

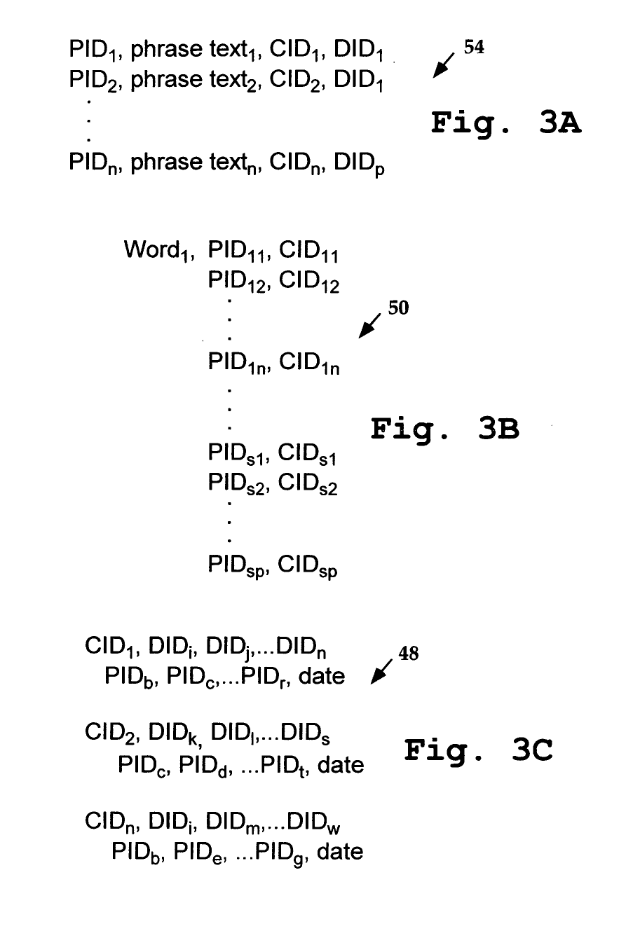

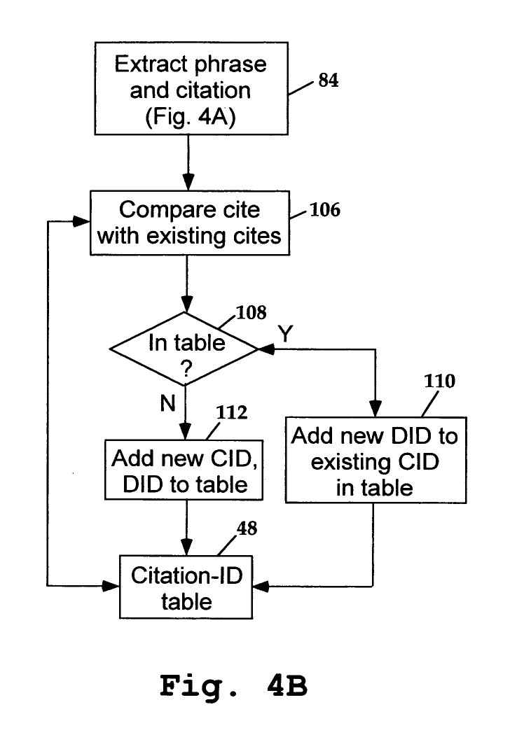

A database in the system, typically run on processor 41, includes in one embodiment a citation-ID table 48, a word-records table or word index 50, a document-ID-table 52, a phrase-ID table 54, and a user-ID table 56, all of which will be described below, e.g., with reference to FIGS. 3A-3E. Also included in the database may be a co-occurrence matrix 58 described below with reference to FIG. 6. The database also includes a database tool that operates on the server to access and act on information contained in the database tables, in accordance with the program steps described below. One exemplary database tool is MySQL database tool, which can be accessed at www.mysql.com.

It will be appreciated that the assignment of various stored documents, databases, database tools and search modules, to be detailed below, to a user computer or a central server or central processing station is made on the basis of computer storage capacity and speed of operations, but may be modified without altering the basic functions and operations to be described.

C. Processing Citation-rich Documents

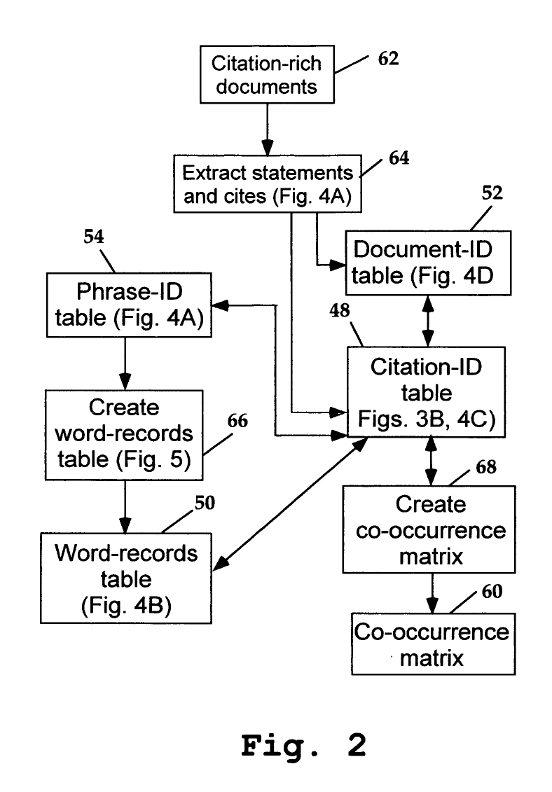

FIG. 2 is a flow diagram of the high-level steps used in processing citation-rich documents to produce the various database tables and matrices employed in the system. The citation-rich documents, indicated at 62, may be any collection, typically a large collection of up to several thousand to several million documents, such as a large collection of scientific or scholarly publications, reported legal cases, e.g., appellate cases, or legal documents such as opinions and briefs, all of which contain multiple citations or cites, e.g., references to other cases or other articles or scholarly works. The documents typically include a combination of internal, archived citation-rich documents, such as legal documents generated within a law firm, and publicly available citation-rich documents, such as reported appellate case or published journal articles.

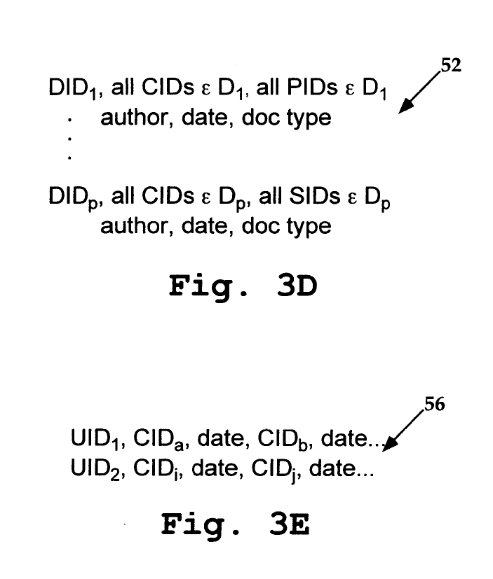

The program operates to extract the citations (or cites) from each document, and the typically one phrase (also referred to herein as a statement or a “holding” or “summary” or “proposition”) that the cite “stands for” in that particular document. This step, which is indicated at 64 in FIG. 2, will be detailed below with reference to FIG. 4A. Each phrase extracted from a document (and identified with one or more cites) is placed in phrase-ID table 54, which has as its key locator, a phrase identifier (PID), where each phrase has a separate identifier. As noted above, identical phrases from different documents are typically assigned different phrase identifiers; that is, the program need not attempt to consolidate identical or near-identical phrases into a single phrase. FIG. 3A shows typically table entries that include, for each PIDᵢ entry, the text of the extracted phrase, a citation identifier or tag (CIDⱼ) that identifies the citation associated with that phrase (the citation identifier is determined as described below with reference to FIG. 4B), and a document identifier (DIDₖ) that identifies the document from which the phrase is extracted. Typically a document will contain many different CIDs, and the same CID in many different documents may be associated with many different phrases. The phrases associated with any given CID may be identical, similar in wording and/or content, or different in content, indicating that the particular CID “stands for” more than one holding or proposition. In addition to the table information indicated, the phrase-ID table may include, for each phrase, the full text of a document passage, e.g., paragraph, containing that phrase.

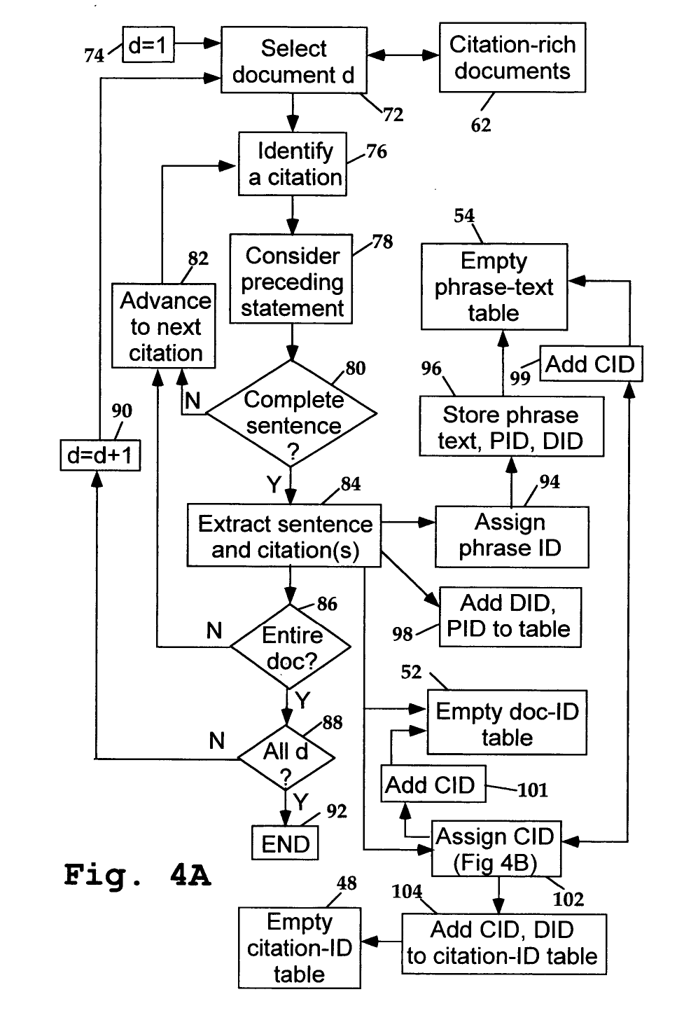

The phrase-ID table is used in generating a word-records table 50, according to the steps indicated at 66 in FIG. 2 and detailed below with respect to FIG. 5. The key locator for the word-records table is a phrase word, such as wordᵢ shown in FIG. 3B, and for each word, there is a list of all PIDs containing that word, and for each phrase PID, the CID associated with that phrase. As indicated in FIG. 3B, most words in the table will contain a relatively long list of phrases and associated CIDs. Preferably, the words in the table do not include generic words, such as common pronouns, conjunctions, prepositions, etc., as well as certain generic words that are common to a large number of phrases, such as (in the legal field) “legal,” “law, ” “standard,” “test,” “court,” and the like (in the scientific field), such words as “study,” “experiment,” “finding,” “results,” “conclusion,” and “data,” and the like. The CID associated with each PID in the word-records table is determined according to the method in FIG. 4B.

Returning to FIG. 2, the extraction program described in FIG. 4A also generates a citation-ID table 48, a portion of which is shown in FIG. 3C. The key locator in this table is citation ID or tag (CID), and the table contains, for each CIDᵢ, all of the documents DIDᵢ in the database that contain that citation, all of the phrases PlDₖ associated with that citations, and optionally, other bibliographic information for that citation, such as date, author, journal or reporter, and volume and page number, and the name of the client, i.e., client ID to whom or for whom the document was prepared.

As will be described further below, the DIDs for each citation may be stored in the citation table as a number string composed of N digits, where each digit position in the string represents one of the N documents, and that digit contains either a “1,” if the document corresponding to that index number contains the specific citation, or a “0” if it does not. Thus, a DID string for a given citation in the citation table of the form “0000100001 10000110 . . . ” indicates that the citation is present in the documents represented by index numbers 5, 10, 11, 17, 18, and so forth, and not present in those documents where a “0” appears. This vector representation of documents (where each string position represents a document component of the vector and the 0 and 1 values are the vector coefficients) allows for fast document comparison operations to be described below.

It will be appreciated that in constructing the above string representation of documents, the program requires a temporary look-up file that lists the index position of each DID, so that the program knows which index position is associated with each DID. Then, in constructing the document-string entry for each citation in the citation table, the program will record all DIDs containing that citation, from the look-up table, will determine the corresponding document-string index positions of all of those DIDs, and construct a string containing a 1 at all of index positions corresponding to the DIDs containing that citation.

Also as indicated in FIG. 2, the extraction program described in FIG. 4A also generates a document-ID table 52, a portion of which is shown in FIG. 3D. The key locator in this table is document ID (DID), and the table contains, for each DID, all CIDs for citations contained in that document, all PIDs for phrases contained in that document, and optionally, additional document information, such as author, client number, and date.

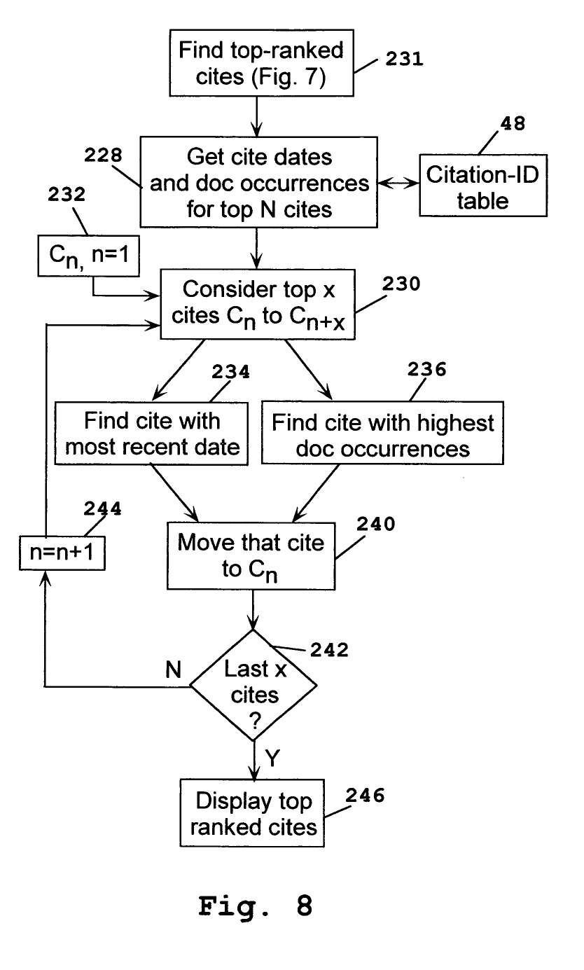

Also as seen in FIG. 2, the citation-ID table is used in creating a co-occurrence matrix 58. The co-occurrence matrix, a portion of which is shown below in FIG. 10, is an W×W matrix of W row citations, such as citations Cᵢ, Cⱼ, and Cₖ, times W column citations, such as citations C₁, C₂ C₃, and C_{w}, where the value of each matrix entry for a CᵢCⱼ matrix pair is the number of times the two citation Cᵢ and Cⱼ appear in the same document, normalized to a common value, e.g., such that the sum of all matrix values in a given row or column equals 1. The matrix is formed in accordance with the method described with respect to FIG. 6, and is indicated at 68 in FIG. 2. Finally, user-ID table 56 in the embodiment of the system illustrated is a table of all users, identified by user-ID or UIDₗ, and for each user, each citation CIDₘ selected by that user in the course of system operation, along with the date that the particular citation was selected by that user.

FIG. 4A is a flow diagram of steps employed by the system in extracting citations and associated phrases from each of a plurality of citation rich documents 62. For purposes of illustration, documents 62 are legal documents, either opinions briefs or other documents generated by lawyers, or case-law decisions, e.g., appellate decisions published by court reporters. It will be appreciated from the following description how the system would be modified for extracting citations and phrases from other citation-rich documents, such as scientific or other scholarly works, patents, or any other type of documents in which phrases in the document are supported by reference citations. In particular, it is noted that in most citation-rich legal documents, the citation is often given in full within the body of the document, whereas in many other types of citation-rich documents, the full citation is given as a footnote or in a bibliographic list of references at the end of the document.

The total number of documents to be processed may be quite large, e.g., several hundred thousand citation-rich documents or more. Each document, as it is selected at 72 (with the counter initialized at 1 for the first document, at 74) is assigned a new, next-up document ID, which will follow the document through the construction of the database tables.

For purposes of specific illustration, it is assumed that the document being processed is a patent-validity opinion, and that the particular passages the program first encounters are those Paragraphs 1-4 below, which will be used to illustrate the operation of the system in extracting citations and their corresponding phrases:

[Paragraph 1] The presumption of validity of patent claims, like all legal presumptions, is a procedural device, not substantive law. However, it does require the decision maker to employ a decisional approach that starts with acceptance of the patent claims as valid and that looks to the challenger for proof of the contrary. Accordingly, the party asserting invalidity has not only the procedural burden of proceeding first and establishing a prima facie case, but the burden of persuasion on the merits remains with that party until final decision. TP Laboratories, Inc. v. Professional Positioners, Inc., 724 F.2d 965, 971, 220 USPQ 577, 582 (Fed. Cir. 1984); Richdel, Inc. v. Sunspool Corp., 714 F.2d 1573, 1579, 219 USPQ 8 (Fed. Cir. 1983).

[Paragraph 2] The challenging party's burden also includes overcoming deference to the PTO's findings and decisions in prosecuting the patent application. Deference to the PTO is due “when no prior art other than that which was considered by the PTO examiner is relied on by the attacker.” American Hoist & Derrick Co. v. Sowa & Sons, 725 F.2d 1350, 1359 (Fed. Cir.), cert. denied, 469 U.S. 821, 83 L. Ed. 2d41, 205 S. Ct. 95 (1984). Conversely, no such deference is due when the party challenging the patent raises prior art or evidence that was not considered by the PTO in its decision and evaluation of the patent application:

[Paragraph 3] When an attacker simply goes over the same ground traveled by the PTO, part of the burden is to show that the PTO was wrong in its decision to grant the patent. When new evidence touching validity of the patent not considered by the PTO is relied on, the tribunal considering it is not faced with having to disagree with the PTO or with deferring to its judgment or with taking its expertise into account. American Hoist, at 1360.

[Paragraph 4] The description must clearly allow persons of ordinary skill in the art to recognize that the inventor invented what is claimed.” Thus, an applicant complies with the written description requirement “by describing the invention, with all its claimed limitations, not that which makes it obvious,” and by using “such descriptive means as words, structures, figures, diagrams, formulas, etc., that set forth the claimed invention.” Lockwood, supra.

The first step in the document processing is to identify a citation, at 76. This is done, in the case of legal citations, by the program looking for certain words, abbreviations, and indicia that are common to legal citations. For example, the program might look for one of the following cues characteristic of a legal case name: “In re,” “ex parte,” or “v.” In addition, the program might look for the abbreviation for a state or federal reporter, such as “F.2d,” “F. Supp,” or “SCt,” or “USPQ”, all of which can be entered into a relatively small library of case reporters at the state and/or federal level. If a reporter name is found, the program could confirm by looking for numbers on either Side of the reporter abbreviation. Finally, the case citation is likely to include the name of the trial or appellate court which handed down the decision, and the program can further confirm a citation by identifying a court abbreviation, such as “SCt,” “NDCa,” “Fed. Cir.”, and so forth, followed by a year, e.g., “1999,”, “2004.” indicating the year that the decision was published. A similar approach would apply, for example, to citation-rich scientific or technical publications, where the citation would be identified on the bases of one or more of (i) a standard abbreviation for each of a plurality of journals that are likely to be encountered (stored in a small dictionary); (ii) standard journal identifier information, such as volume, page and date, and (iii) a list of authors, last name, followed by an initial, and usually at the beginning of the citation.

In the example given above, the two citations in Paragraph 1 can each be identified by (i) a case name containing a “v.” (ii) the names of court reporters “F.2d” and “USPQ2d,”, (iii) a number preceding and following each court reporter, and (iv) a court name abbreviation and year of publication (typically in parentheses). The end of the first cite and beginning of the second one can be identified by one or all of (i) a semi-colon at the end of the first cite; (ii) the court name abbreviation and year at the end of the first cite, and (iii) a new case name at the beginning of the second cite.

TP Laboratories, Inc. v. Professional Positioners, Inc., 724 F.2d 965, 971, 220 USPQ 577, 582 (Fed. Cir. 1984); Richdel, Inc. v. Sunspool Corp., 714 F.2d 1573, 1579, 219 USPQ 8 (Fed. Cir. 1983).

Similarly, the sole cite in Paragraph 2 is identified by (i) a case name containing a “v.” (ii) the name of a court reporter “F.2d”, (iii) a number preceding and following each court reporter, and (iv) a court name abbreviation and year of publication (typically in parentheses. In addition, the subsequent appeals history of the case may follow the initial cite, this being distinguished from a separate citation by one or more of (i) lack of a semi-colon, (ii) lack of a new case name, and (iii) an abbreviation of the disposition of the appeal, e.g., “cert denied.” As above, the latter abbreviation is included in a “case-citation” abbreviations library that the program accesses during the operation of locating citations.

“American Hoist & Derrick Co. v. Sowa & Sons, 725 F.2d 1350, 1359 (Fed. Cir.), cert. denied, 469 U.S. 821, 83 L. Ed. 2d41, 205 S. Ct. 95 (1984).

It is common in a citation-rich document for reference to be made to a previously-referenced citation, and in this case, the citation may include simply a name in the case name followed by a comma the abbreviation of “supra,” meaning “above,” or “higher up” (in the document), “infra,” meaning “below” (in the document) or “ibid,” meaning “in the same passage or citation,” or alternatively, a name in the case, followed by a comma, and the word “at” followed by a page number, referring to the page in the citation at which the referenced phrase is found.

For example in Paragraph 3, the citation to “American Hoist, at 1360” is recognized by (i) a name in a case name already cited in the document, and (ii) “at” followed by a number. Similarly, the citation in the Paragraph 4 “Lockwood, supra” is identified by (i) a name in a case name already cited in the document, and (ii) a comma followed by the word “supra.” Of course, identifying previously cited references in any document requires that the program keep a list of cited case names during the processing of each documents, so that these can be compared with case-name abbreviations when one of the indicia of a previously cited case is encountered. Once a citation is encountered, it is extracted and placed in a file where the citation will be assigned a CID, as described below with respect to FIG. 4B.

As shown at 78 in FIG. 4A, the program then considers the sentence that immediately precedes the citation. If the sentence is a complete sentence, i.e., begins with a capital letter and ends with a period or semi-colon or with a parentheses which give the citation, the sentence is extracted and assigned to the “phrase” for the citation or citations that it precedes, as a 84. Thus, for example, in Paragraph 1, the complete sentence that precedes each of the two citations is:

Accordingly, the party asserting invalidity has not only the procedural burden of proceeding first and establishing a prima facie case, but the burden of persuasion on the merits remains with that party until final decision.

Similarly, the sentence that precedes the single citation in Paragraph 2 is: Deference to the PTO is due “when no prior art other than that which was considered by the PTO examiner is relied on by the attacker.”

This preceding sentence is the phrase or holding (or one of the phrases or holdings) that will be assigned to the associated citation for the particular document from which the phrases is extracted. As indicated at 84 in the figure, the sentence (phrase) is extracted, assigned a phrase ID number at 94 (each phrase is assigned a different, next-up number) and the phrase text is then stored, along with the PID and DID, at 96. Once the CID has been identified, as described below with respect to FIG. 4B, and indicated at 102 in FIG. 4A, the phrase PID, text, CID, and DID are added to table 54 in constructing the phrases-ID table in the system.

If, during the processing of text that precedes a citation, an incomplete sentence is encountered, e.g., because a citation occurs in the middle of the phrase, the partial sentence back to the beginning of the sentence may be used as the citation phrase, or the entire phrase may be used. If the phrase contains two or more citations, each citation is assigned to the entire statement. In some case, the case name will precede the associated phrase. This format can be recognized typically by the words “In” or “according to” or “as stated in” (name of case), followed by the associated phrase.

As the program extracts sentences and citations, it also adds the PID and DID at 98 to an empty (or growing) document-ID table 52, and assigns the citation a CID at 102. The document-ID table also receives author and date information as indicated above. The assigned CID is added to the document-ID table at 101, and to the phrase-ID table at 99. The CID is also added, at 104, as the key locator to a empty (or growing) citation-ID table 48, along with the associated DID, PID and citation date.

This processing is continued, through the logic of 86 and 82, until all citations in a document and associated phrases have been identified, and all PIDs, associated phrase texts, CIDs, associated citations, DID, and other identifying information has been placed in the phrases-ID, citations-ID and documents-ID tables, as just described. Each document is similarly processed through the logic of 88, 90, until all of the citation-rich documents in 62 have been so processed.

FIG. 4B is a flow diagram of the operation of the program in assigning new CIDs to each newly-identified citation. After extracting a new citation and its phrase, at 84, and as described above, the new cite is compared at 106 with existing cites in citation-ID table 48. This comparing entails comparing each name in the new citation with each name in each of the existing cites in table 48. If a name match is found in any citation, the program compares the reporter information between the new and searched citation. If a reporter-information match is found, e.g., identical reporter and adjacent numbers, the two citations are considered identical. In this case, the “new” citation is assigned the number of the already-assigned citation, at 110, and that citation number is assigned to the various database tables. In particular, and as shown in the figure, the document ID from which the citation was extracted is added to the list of existing DIDs in for that assigned CID in the citation-ID-table. If the newly-extracted citation is not already in the citation-ID table, the citation is assigned a new number, placed as a new citation entry in the citation-ID table, and also added to the other database tables.

The types and variations of phrases extracted from citation-rich documents can be seen in the Example below, where a tagged-phrase database was constructed from tagged phrases extracted from about 1,000 published appellate decisions in the field of patent law. In general, many and often most of the phrases associated with a given citation tend to be similar in meaning, particularly where the number of documents containing a citation is relatively small, e.g., less than 10. However, with citations that are found in a large number of documents, e.g., 20-50 or more, a fairly wide variation in the content of the phrases can be expected.

Where the tagged phrases in a citation-rich document are footnotes, the program notes each footnote, accesses the footnote information, and asks: Is the footnote a reference citation? This question is answered, as above, by checking for citation information, such as known journal abbreviations, and/or other standard citation indicia, such as volume, page, date, and author indicia. If the footnote is confirmed as a citation, the sentence associated with the footnote is stored as a citation, and given the assigned citation.

Alternatively, the citation format may be a parenthetical entry containing an author name or names, typically followed by the year of publication. In this format, when a single or small number of names in parenthesis is found, the program checks the bibliography at the end of the document, and looks for that name among the listed authors, which typically appears as at the beginning of the citation. If a citation is found, the sentence associated with that citation is then stored as a tagged phrase.

Where other citation formats are used, one would simply modify the tagged-phrase extraction program so that (i) each occurrence (notation) of a citation is noted, (ii) the program retrieves the actual citation from the document, and (iii) that citation is associated with the associated phrase in the document.

D. Generating a Word-records Table and an Affinity Matrix

As noted above, the program uses non-generic words contained in the phrases stored in the phrase-ID tables the phrase texts to generate a word-records table 50. This table is essentially a dictionary of non-generic words, where each word has associated with it, each PID containing that word, and optionally, for each PID, the corresponding CID for that phrase.

In forming the word-records or word index file, and with reference to FIG. 5, the program creates an empty ordered list 50, and initializes the PID to p=1, at 120. The program now retrieves PID₁ from the phrases text table at 54, and stores a list of non-generic words in the phrase, and also reads in the associated identifiers for that phrase, at 122. With the word number initialized at 1, the program selects the first word w in phrase s, and asks, at 128, is word w already in the word-records table. If it is, the word record identifiers (associated PID and CID) for word w are added to word-records table 50 for that word in the table, at 132. If not, a new word entry is created in table 50, at 131, along with the associated PID and CID identifiers. This process is repeated, through the logic of 134, 135, until all of the non-generic words in phrase p have been added to the table. Once a phrase has been processed, the program advances, through the logic of 138, 140, until all phrases in the phrase-text table have been processed and added to the word-records table, terminating the processing steps at 142.

In one exemplary embodiment, every verb-root word in a phrase is converted to its verb root; that is, all verb-root variants of a verb-root word are converted to a common verb-root word.

The system also may include one or more “citation affinity” matrices used in various system operations to be described below. As used herein, “citation affinity matrix” refers to an N×N matrix of N citations, where each matrix value tag i×tag j indicates the affinity of tags (citations) i and j in documents from which the N citations are extracted. This section considers, as an exemplary affinity matrices, a co-occurrence matrix 58 whose matrix values are the normalized number of document co-occurrences of each pair of citations.

FIG. 6 is a flow diagram of steps employed in the system for generating co-occurrence matrix 58. As noted above, this is an N×N matrix of all N citations, where each i×j term in the matrix is the number occurrence of all documents in the system that contain both CIDᵢ and CIDⱼ, where the matrix values have been normalized to 1, that is, the matrix values have been adjusted so that the sum of all of the matrix values for a given citation in a matrix row is one. To construct the matrix, Cᵢ is initialized to i=1 (150), and the program selects at 152 citation C₁ from the citation-ID matrix 48, as indicated at step 152, and retrieves all of the DIDs for that CID, at 154. A second citation count at 158 is set at j=1 for citations Cⱼ, and a second citation Cⱼ is selected from table 48. If Cⱼ is the same as Cᵢ, the program advances to the next Cⱼ, through the logic of 161 and 166, and a zero is placed at the Cᵢ×Cᵢ matrix position (on the matrix diagonal). If Cᵢ and Cⱼ are different cites, the program retrieves all documents for Cⱼ, at 162, and then counts the number of documents (DIDs) that contain both Cᵢ and Cⱼ. This “co-occurrence” value is added, at 168, to matrix 58.

This process is repeated, through the logic of 164, 166 until all Cᵢ×Cⱼ co-occurrence values have been determined for the selected cite Cᵢ. The program now proceeds to the next cite Cᵢ₊₁, through the logic of 170, 172, until the matrix values for all W citations have been determined, at 174. The matrix values for each matrix row may now be normalized to a sum of 1, as indicated above.

E. Statement-based Searching for Citations, Phrases, Documents Passages or Documents

This section considers the operation of the system in finding a citation, phrase, document passage and/or a document of interest to a user, by statement-based searching. As will be appreciated from the search procedures described below, the statements represent a content-rich shorthand to the subject matter, providing a high-content “hook” to a citation, phrase, passage or document of interest. Further, since the phrase is typically a short, pitch summary of an idea of interest, there will usually be a high word overlap between the query statement and phrase sought to be retrieved. In addition, where the search is used to find documents of interest, the search procedure can be exhaustive in the sense that the user can continue to add different-content search queries until a desirably small number of “candidate” documents are found. Also as will be seen, the citations provide a medium by which a variety of useful information mined from the documents can be exploited in knowledge management functions, e.g., to guide and enhance the search. Although the method and system operation will be described with respect to finding legal citations, document passages, and documents, based on user-input legal statements or holdings, it will be appreciated how the method and operation apply to searching for any type of citations and citation-rich documents, e.g., scientific articles, or other scholarly works.

The search for a pertinent phrases and/or associated citations has one of at least four purposes, in accordance with the invention. The first objective is database research, where the user desires to identify one or more citations, e.g., a legal citation, that can be cited in support of a given proposition or summary statement, as will be described in Section E1 below.

A second purpose in searching for phrases of interest is to locate text passages of interest from citation-rich documents. As noted above, the phrase-ID table described with respect to FIG. 3A may include, in addition to the text of each phrase, the text of the entire passage, e.g., paragraph, containing that phrase. With this table feature, a user can select a given matched phrase, and request that the program display the entire document passage containing that phrase. This feature allows the user to quickly locate passages of interest, e.g., as template passages in preparing a new document, in a large database of archived document. In particular, the user does not need to know who authored the document, when it was prepared, or even its general content in order to quickly retrieve a relevant passage from the document.

A third purpose of searching for phrases and related citations is for retrieving one or more citation-rich documents of interest. In general, a search for a desired document involves, from the user's point of view, finding a document containing a number of different citations that represent each of a number of different phrases, e.g., legal holdings. The search for a citation-rich document of interest can therefore be viewed as an extension of the above phrase/citation search, but where the document of interest is identified as having each of a plurality of phrases/citations of interest. The assumption behind this method is that each citation-rich document can be identified—in many cases, uniquely identified—by a small number of statements or propositions which collectively define the substantive content of the document. By finding a document containing each of these phrases of interest, the user can identify one or a small number of documents that contain the content of interest. The method for retrieving citation-rich document of interest, in accordance with this aspect of the method, is detailed below in Sections E2 and F.

A fourth purpose of a citation search is to provide the user a citation link between a “fuzzy” user query statement and a well-defined group of data that are all linked to the citation. Thus, by inputting a query statement that simply expresses an idea or concept of interest, the program links the user, through one or more associated citations, to a large body of well-defined data. This feature has a number of applications in information management that will be discussed in Section H below.

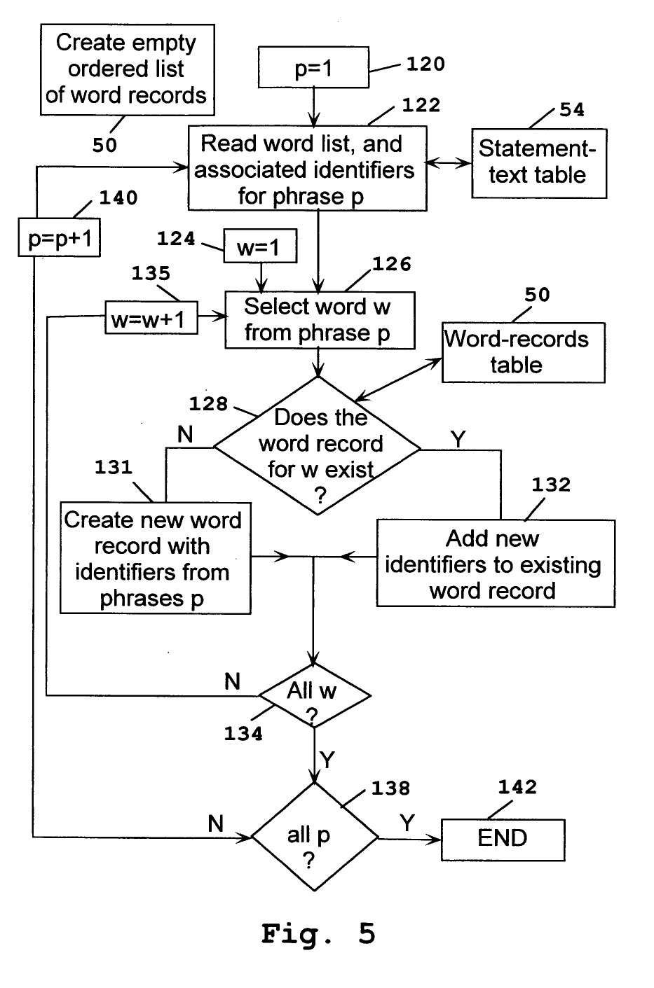

E1. Retrieving phrases and citations. Individual citations are identified and selected, in accordance with one aspect of the invention, by the user entering a word query that approximates a phrase of interest, e.g., a legal holding or proposition, or contains key words that are associated with the phrase of interest. The system then searches the database and returns phrases that have the closest (highest-ranking) word match with that query, along with pertinent citation information associated with that phrase, as illustrated in FIG. 7. As a first step in the search, the program converts the user query, which can include either a user-input phrase or a user-selected phrase into a search vector. The search vector may be composed of word and optionally word-pair terms, and for each term, a coefficient that indicates the weight that term is to be given, relative to other terms in the vector. In one embodiment, the vector terms are simply all of the non-generic words contained in the paragraph summary, with each word being assigned a coefficient value of 1. In this embodiment, the program simply reads the paragraph summary, extracts non-generic words, converts verb words to verb-root words, and assigns each term a coefficient of 1. If a more refined search is desired, the program may operate to extract both non-generic words and proximately formed word pairs in constructing the search vector, and assign to these terms either the same coefficient, e.g., 1, or a coefficient related to the term's selectivity value and optionally, inverse document frequency (IDF) (in the case of word terms), as described in co-owned fully in co-owned published PCT patent application for “Text-Representation, Text Matching, and Text Classification Code, System, and Method,” having International PCT Publication Number WO 2004/006124 A2, published on Jan. 14, 2004, which is incorporated herein by reference in its entirety and referred to below as “co-owned PCT application.”

Although not shown here, the vector may be modified to include synonyms for one or more “base” words in the vector. These synonyms may be drawn, for example, from a dictionary of verb and verb-root synonyms such as discussed above. Here the vector coefficients are unchanged, but one or more of the base word terms may contain multiple words, again as described in the above co-owned PCT patent application. The target words and coefficients are stored at 201 in FIG. 7.

As indicated above, the search operates to find the phrases in the system having the greatest term overlap with the target search vector terms. Briefly, an empty ordered list of PIDs, shown at 200, stores the accumulating match-score values for each PID associated with the vector terms. The program initializes the vector term (e.g., word) at w=1 (box 202) and retrieves (box 204) the first word and associated coefficient from target words 201 and retrieves all of the PIDs associated with that word from word-records table 50. With the PID count set to 1 (box 210), the program gets a PID associated with word w (box 208). With each PID that is considered, the program asks, at 212: Is the PID already present in list 200? If it is not, the PID and the term coefficient for word w are added to list 200, creating the first coefficient of the summed coefficients for that PID. (For the first word of the search vector (w=1), each PID will be newly added to the list.). If the PID is in list 200, the program adds the word coefficient to the existing PID in the list, at 214. This procedure is repeated, through the logic of 216 and 218 until all PIDs for word w have been considered and added to list 200. The program then advances to the next search word, through the logic of 220, 222, and the process is repeated for all PIDs associated with that word.

When all of the words in the search vector have been considered (box 220), the program adds the coefficient scores for each PID, and ranks the PIDs by match score, at 226. By accessing CID-ID table 48, the program gets all cites, dates and document occurrence (number of documents containing that cite) for the top N phrases, for example, all phrases whose match score is at least 75% of a perfect match score, as indicated at 225. For these top N phrases, the program finds a cumulative match score for each CID, at 227, and ranks these CIDs by total match score at 229. The user can elect to view the citations and the associated phrases displayed by total match score, by match score ranked by citation date or match score ranked document occurrence.

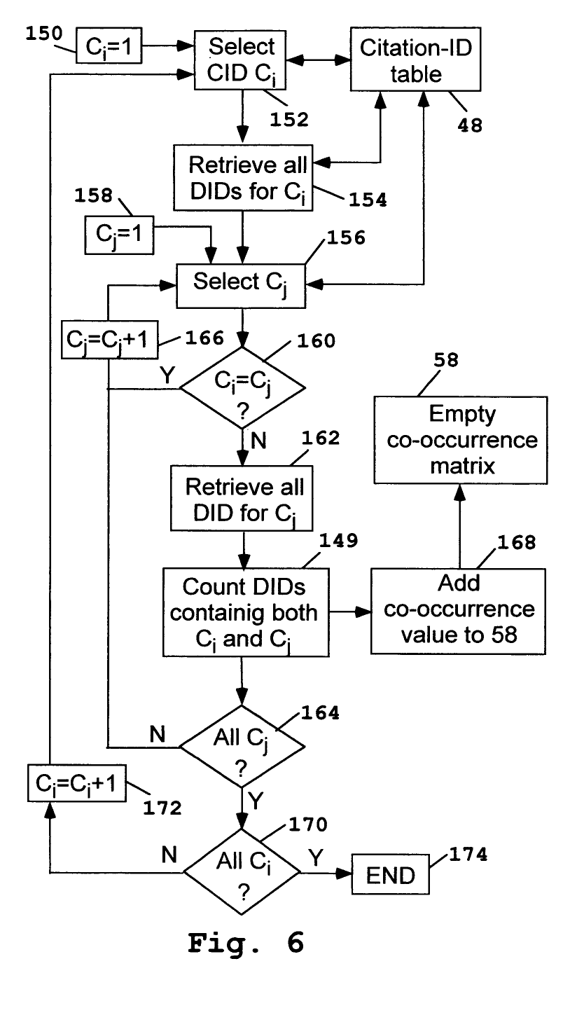

The system operation in carrying out the latter two displays will now be considered with reference to FIG. 8. For each cite displayed, the program can also display the top-ranking phrase associated with that citation. Thus, several similar phrases may contribute to the cumulative ranking score of any citation, with the top scoring of those phrases being displayed to the user for that cite.

The purpose of the ranking operations shown in FIG. 8 is to re-rank the citations, previously ranked according to total phrase score, according to citation date or document occurrence of that citation, i.e., number of documents containing that citation. The re-ranking is done by a moving window method that considers, at any one time, a small window of X ranked citations, where X is typically 5-10. Within this window, the most recent citation (where the citations are being ranked by date) or the citation with the highest document occurrence (where the citations are being ranked by document occurrence) is moved to the top of the ranking within the window, and the window then moves “down” one citation, and repeats the process of moving the citation with the top-ranked date or document occurrence to the top of the new X-citation window. Thus, a citation can advance in ranking by X citations at most, so that the final rankings reflect both by total citation score and citation date or citation document occurrence.

Box 231 in FIG. 8 shows the top-ranked cites obtained from each stage of a user-directed search, as described above. Accessing citation-ID table 48, the program gets the citation dates and document occurrences for these top-ranked CIDs, at 228. The program is initialized to citation Cₙ, n=1, where n represents the rank of the ranked citations and n=1 indicates the top-ranked citation (box 232). As indicated at 230, the program considers the top X citations, that is, cₙ to c_{n+X}, where X is typically 5-10 (box 230). If the citations are being ranked by citation date, the program finds the most recent citation within this window, as at 234, where citation dates may be determined by one or more of (i) year of citation, (ii) month and year of citation, if available, and (iii) volume of reporter or journal, if the same for two different citations. The most recent citation is then moved to the top of the rankings within the window, e.g., become or remains c₁ for the first window position (box 240).

Similarly, if the re-ranking is being carried out on the basis of document occurrence, the program finds the citation with the highest document occurrence within this window, as at 236, where document occurrence is determined by adding the documents associated with each citation, in the Citation-ID table. The most heavily cited document is then moved to the top of the rankings within the window, e.g., become or remains c₁ for the first window position (box 240).

This process is repeated for each successive X-citation window, through the logic of 242, 244, until the window spans the last X citations in the ranked list. The newly ranked citation listed, re-ranked to favor either citation date of document occurrence, are then displayed at 246. As above, the citation may be displayed along with its date, document occurrence value, and top-scoring phrase. More generally, the system can display the search results in a variety of ways, depending on user selection: For example:

1. A display of all the top-ranked phrases, including phrases that may be from the same citation.

2. A display of the top-ranked phrases for each citation; In this mode the program scans through the ranked phrases, taking the top phrase for each new different citations and presents this phrase and the corresponding citation.

3. A display of top-ranked phrases and citations, arranged to place the most recent citations first (see below); and

4. A display of top-ranked phrases and citations, arranged to place the citations with the highest document occurrence first.

When the phrases are displayed, in one or more of the above formats, the user may either select one or more phrases from the display, or select one of the displayed phrases as a more representative or robust search query, and rerun the search with that phrase as the user-input statement. The latter, iterative approach allows the user to make an initial rough guess at the wording of a desired phrase, then refine that query by using a representative phrase actually contained in the system.

When the search is complete, the user can select one or more particular citations of interest, and further request a display of all phrases corresponding to a given citation. This, along with the citation date and court, will provide the user with a basis for deciding if any one citation is a desired one. For example, in reviewing all of the phrases associated with a given citation, the user may decide that the citation holding is actually contrary to holding being sought. It can be appreciated displaying all of the phrases associated with a given citation gives the user a relatively complete overview of the pertinence of that citation.

The Example below illustrates two search queries for phrases and associated citations, in accordance with this embodiment of the invention. The results indicate the type and number of closely matching phrases that can be expected in the search. The results also provide a sampling of other phrases associated with two of the citations, to illustrate the type and variation of phrases associated with a typical citation.

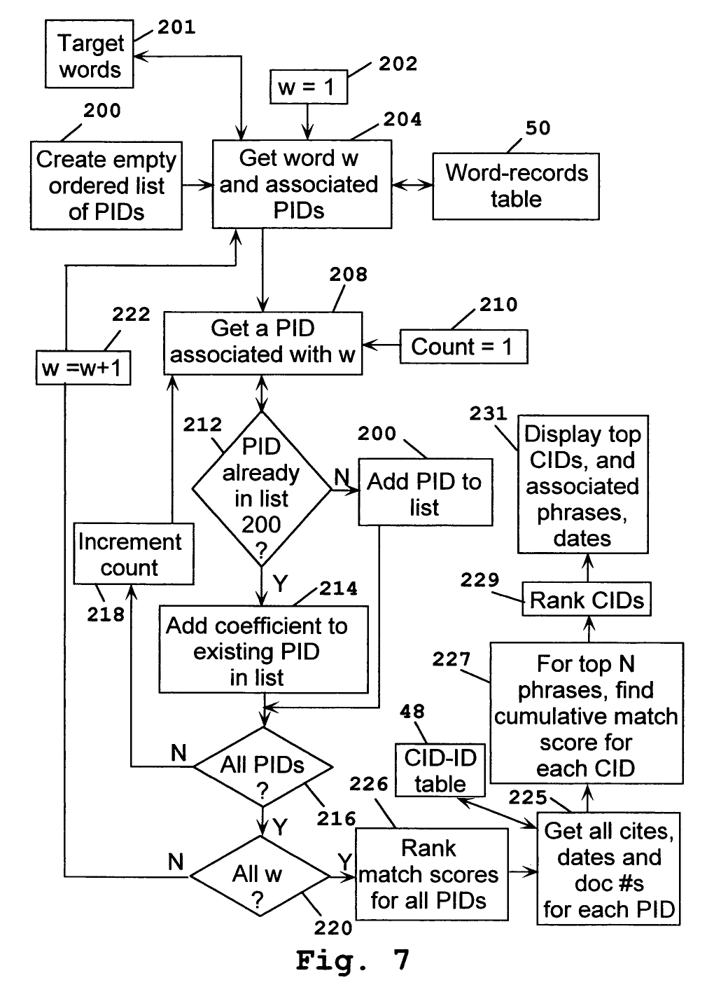

E2. Retrieving a document of interest. FIG. 9 shows steps in a document-retrieval search carried out in accordance with an embodiment of the present invention. In overview, the search involves first identifying a number of different propositions or concepts that are likely to be associated with the document of interest. Each of these propositions represents a different “level” of search, where at each level, the user attempts to find citations associated with that given proposition. After some number of levels, the number of documents containing at least one citation from each level becomes sufficiently small that the user can efficiently review the retrieved documents or phrases found therein, to evaluate whether one or more optimal documents have been retrieved. The present section described a search based on successive levels, where the input statement at each level is supplied by the user. Section F below describes a mode of operation in which the program itself supplies additional input citations for additional levels of search.

As a first step, the user will retrieve one or more “first-level” citations that are likely to be found in a document of interest, as indicated at box 176 in FIG. 9. This is done according to the search method described above with respect to FIG. 7, with the program display being selected to show top-matched phrases and citations, as described above with respect to FIGS. 7 and 8. Typically at each level of searching, the user will typically select two or more citations at 178 that are substantially equivalent in a desired holding (phrase), with the idea that the document being sought may have any one or more of the “equivalent” selected citations. The two or more selected citations thus serve as “synonyms” of each other with respect to the user query. If desired, the user can repeat the first-level search with a selected phrase, as indicated at 180 in FIG. 9, and as discussed above.

The user now proceeds to a second level of search, beginning at box 182, where one or more citations associated with a different-content phrase will be displayed and selected. The three boxes for this second level, indicated at 182, 184, and 186, encompass the same system operations represented by boxes 176, 178, and 180, respectively. The display at the second level may also include a document-number display that indicates to the user, for each citation presented, the number of documents in the system containing one or more of the selected citations from the first level and the displayed second-level citation. If this number is small enough, the user can request a display of the document IDs containing the identified citations. If not, the search is continued until enough different citations (or groups of citations, each corresponding to a given phrase) have been identified for the system to narrow the search to a desirably small number of documents for user review. As with the first stage display, the user may select two or more phrase with similar or equivalent phrases, to enhance the possibility of finding a document with that phrase.

At any stage in the search method after the first stage, but typically after the second or third stage, the user can switch to an automated or system-directed mode in which the system uses mined information from the documents to identify additional citations that (i) are associated with citations already selected by the user, e.g., in the first two stages of the search, and (ii) limit the total number of documents within the scope of the search in a systematic way. The selection of either user-directed or system-directed mode is illustrated in the bifurcated steps found in the middle of the flow diagram, where the box 188 indicates the search for an additional user-directed level of citations and box 198 indicates a system-directed search for additional citations. In either case, the user will select one of more of the citations displayed from this next stage of the search (box 190), and the system will indicate, as part of the display, the total number of documents containing one or citations from each level of search. The operation of the system in the automated mode will be described below in Section F with reference to FIGS. 10-14.

If the number of documents identified by the search at this stage is suitably small, e.g., 1-20 documents, so that the documents identified can be assessed without unreasonable effort, the search will be complete, as at 192, in which case the system will rank the documents according to citation match score, and/or date, at 194, by accessing document-ID table 52, and display the results to the user at 196. Otherwise, the search process will be iterated to one or more additional stages, either in the “user-directed” or “automated” mode, until a suitably small number of documents is identified.

F. System-directed Operations Based on Tag-pair Affinities

The citation-affinity matrices discussed above represent mined citation information that can be used in a variety of applications to link or more citations in one group to one or more citations in another group. Section F1 described how tag affinities can be used to enhance the search for a citation-rich document of interest. Sections F2 and Fe discuss other operations based on tag-pair affinities.

F1. Document retrieval The system-directed search method described in this section uses tag affinities to identify citations that, when combined with citations already selected by the user during the course of a document search, will guide the user in the overall search process. For purposes of illustration, it will be assumed that the user has already carried out first- and second-level selections for citations, as described above, and selected first-level citations cᵢ, cⱼ, and cₖ and second-level citations cₗ, cₘ, cₙ, and cₒ. The purpose of the system-directed method in this example is to use these two groups of selected citations to guide the user toward a desired search document(s), by one or more system-directed search levels.

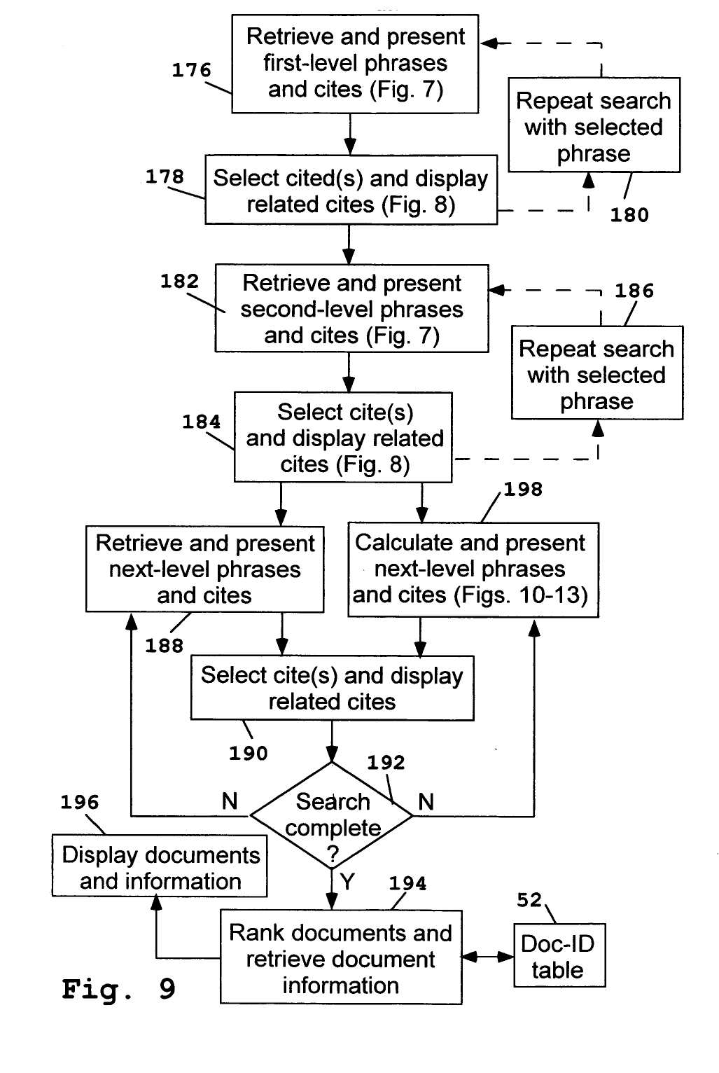

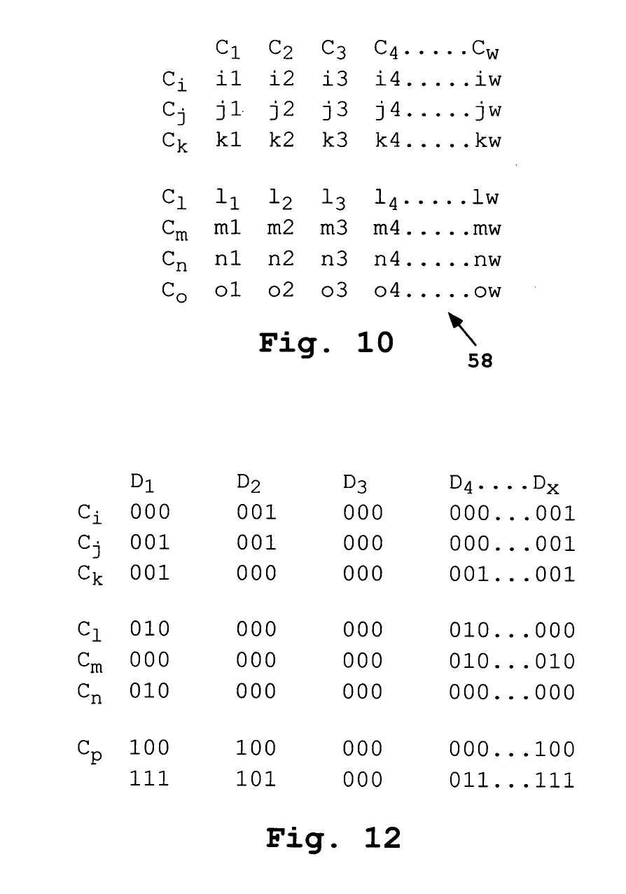

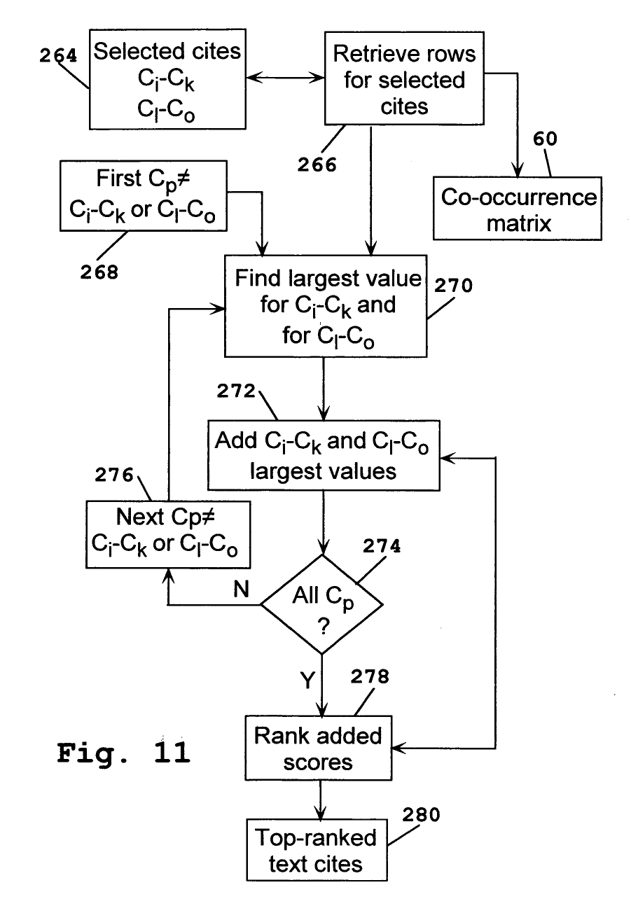

The system-directed method has two separate operations. In the first operation, described below with respect to FIGS. 10 and 11, the program uses data from co-occurrence matrix 58 to find citations that are likely to co-occur with the already selected citations, based on their co-occurrence values with the selected citations. In the second operation, described below with respect to FIGS. 12 and 13, the system calculates the number of documents containing one or more citations from the user-selected citation group or groups, and one of the “test” citations from the first operation. These test citations are then presented to the user, ranked by order of document occurrence, to prompt or guide the user toward documents of interest.

FIG. 10 shows a portion of co-occurrence matrix 58 that includes the matrix rows for the citations cᵢ, cⱼ, and cₖ selected from the first level search in this example, and the matrix rows for the citations cₗ, cₘ, cₙ, and cₒ, from the second level search. Each row includes “w” co-occurrence values “ip”, the calculated occurrence of citation “i” and citation “p” in the documents of the system. The cites selected from the previous two stages of search are indicated at 264 in FIG. 11. The program accesses co-occurrence matrix 58 to retrieve the matrix rows for these citations, shown FIG. 10. Operationally, the program may retrieve rows cᵢ, cⱼ, cₖ, cₗ, cₘ, cₙ, and cₒ from the matrix and place these rows in the active memory of the program. The citation “columns” c₁ to c_{w} in FIG. 10 are initialized to the first citation cₚ in a row that is not one of the selected citations, at 268.

The next step in the operation is to find for that citation (cₚ) column, the largest co-occurrence value in each group of selected citations, at 270. For example, if the first citation column selected is c₁ in FIG. 10, the program finds the largest value among “i1,” “j1,” and “k1,” and the largest value among “l1,” “m1,” “n1,” and “o1.” These largest values are added, at 272, and the sum stored for that column citation. Alternatively, the program may find the average values of “i1,” “j1,” and “k1,” and the average value of “l1,” “m1,” “n1,” and “o1, ” and add the two average values and store this sum for that column citation. This process 10 is then repeated, through the logic of 274, 276, for the next column citation that is not one of the selected citations. If this next citation is, for example, c₂, the program finds the largest values among “i2,” “j2,” and “k2,” and among “i2,” “m2,” “n2,” and “o2” in FIG. 10, adds the two largest values and stores the sum for that column citation, or alternatively, finds the average value of “i2,” “j2,” and “k2,” and the average value of “i2,” “m2,” “n2,” and “o2”, adds the two average values and stores the sum for that column citation. This process is repeated, at 274, 276, until all citations have been considered. The citation scores are then ranked, at 278, and the top X citations, e.g., 50-200 citations, are selected at 280, completing the first operation of the process.

In the second operation, the documents associated with each of the selected cites, indicated at 264 in FIG. 13, and each of the top-ranked test cites 280 from FIG. 11 are used to find the number of documents containing one or more citations from each of selected groups of citations and a selected one of the test citations. The system first accesses citation-ID table 48 to retrieve the documents associated with each of the citations in 264 (box 282) and each of the top-ranked test cites in 280 (box 284). The entire matrix may be retrieved or only selected rows in the matrix corresponding to the selected cites and test cites. As discussed above, each document list for each citation in the citation table is represented as a string of N binary digits, where N is the total number of documents, each string position represents a given DID, and the digit at any index position represents the presence (“1”) or absence (“0”) of that document in the citation list.

In one embodiment, illustrated in FIG. 12, the document string is further processed so that each string position is expanded to a multi-digit coefficient whose digits are related to the number of previous queries. In particular, the coefficients assigned to the vector terms (index position corresponding to document numbers), at 288, will depend on the group of cites that any particular citation belongs to. In the present example, the system has three citation groups to consider: (i) the first selected group of citations cᵢ, cⱼ, and cₖ, (ii) the second selected group of citations cₗ, cₘ, cₙ, and cₒ, and (iii) one of the test citations from FIG. 11, shown in separate groups in FIG. 12.

For three groups of citations, the system will need three digits or bits to distinguish various combinations of the three groups. As shown in FIG. 12, the first group is assigned coefficients of 001 or 000, depending on whether the associated document contains (001) or doesn't contain (000) that citation. For the second group of citations, the identifying bit is in the second position; thus, coefficient of 010 or 000 depending on whether the associated document contains (010) or doesn't contain (000) that citation. Each cite in the test group is similarly assigned vector coefficients of 100 or 000 to denote the presence or absence of the citation in a given document. The coefficient assignments are indicated at 288 in FIG. 13.

With the test citations cₜ initialized to 1 (box 291), the program selects a test citation cₜ, and finds the combined coefficients for each vector term among the three groups of citations. With reference to FIG. 12, this step can be carried, at each vector term (document ID), by separately inspecting each digit, starting with the right-most digit, and asking: does the column contain any “1” values, i.e., combining the coefficients by an “or” operation. If it does, the middle column of digits is then inspected, and the same question asked. If again a 1 is found, the program looks at the right-most column, and asks the same question again. If again a “1” value is found, that term (document ID) has a score of “111,” indicating that the document contains at least one citation in each of the three groups tested. Whenever a zero is encountered at any of these steps, the program advances to the next vector term (document ID) without needing to complete the inspection of each column of digits for that coefficient. These steps, which are generally at box 292 in FIG. 13, are repeated for each vector term (document-ID) in the vector, e.g., documents D₁ to Dₓ in FIG. 13. When all vector terms have been considered, the program counts the terms with the requisite “111” coefficients, at 294, to determine the number of documents containing at least one citation from each of the first two selected-cite groups and the test cite cₜ under consideration. These steps are repeated for each of the test cites cₜ, through the logic of 296, 298.

In an alternative method, the citation-document strings from the citation table are used directly to calculate a document-number score for each of the selected citations. This can be done in two steps, as follows: In the first step all of the document strings for alternative citations from each given search group, e.g., the first selected group of citations cᵢ, cⱼ, and cₖ, or the second selected group of citations cₗ, cₘ, cₙ, and cₒ, are combined by an “or” operation of the document strings for that group. Thus, in the case of the citations cᵢ, cⱼ, and cₖ, the three document strings for these citations are combined so that a 1 value is assigned at each document position at which at a given document is present in at least one of the three citations, producing a group document string for each group of citations so considered.

Once these group document strings are generated for all previously selected groups of citations, the group strings are tested with each test citation string to determine the number of documents containing at least one citation from each of the previously selected citations groups and the test citation. This can be done by combining the group citation strings and a test citation string by an “and” operation whose effect is to generate a 1 value for a given document only if that document is present in each of the group citation strings and in the test citation string. Once all of the document positions have been considered, these individual document “and” scores are simply added to determine the total number of documents containing at least one of the citations from each of the previously selected citation groups, and the test citation.

At the end of this operation, the program has calculated the document occurrences for each set of citations involving a test citation cₜ, as at 300. The test cites are then ranked according to this calculated document-occurrence value, and presented to the user in rank order, as at 302. In one exemplary method, the system uses the co-occurrence matrix to find the top 200 co-occurring citations (the test citations), calculates the document score for each test citation, and presents the top 50 citations, ranked by document score, to the user. As will be seen below, a citation is typically presented in this context as the citation itself (as it is cited in a document) including citation date, the number of documents containing that citation (and at least one of each previously selected groups of citations), and a phrase associated with that citation. This phrase may be, for example, 3-5 representative phrases selected at random for that citation from the citation-ID table.

If a desirably small group of documents are shown for a particular citation, the user can choose to view each of the identified documents. On command from the user, the program will show the user the different identified documents, display each by document identifiers such as title, author, and date, and citations and corresponding citation phrases associated with that document.

If the user wishes instead to reiterate the system-driven search, the citations just selected become the next group of selected citations, and the program repeats the above steps, using now three selected groups of citations to (i) identify additional citations having a high co-occurrence with at least one citation in each of the three selected citation groups, and (ii) to identify test citations that preserve the most documents, in combination with the three selected citation groups.

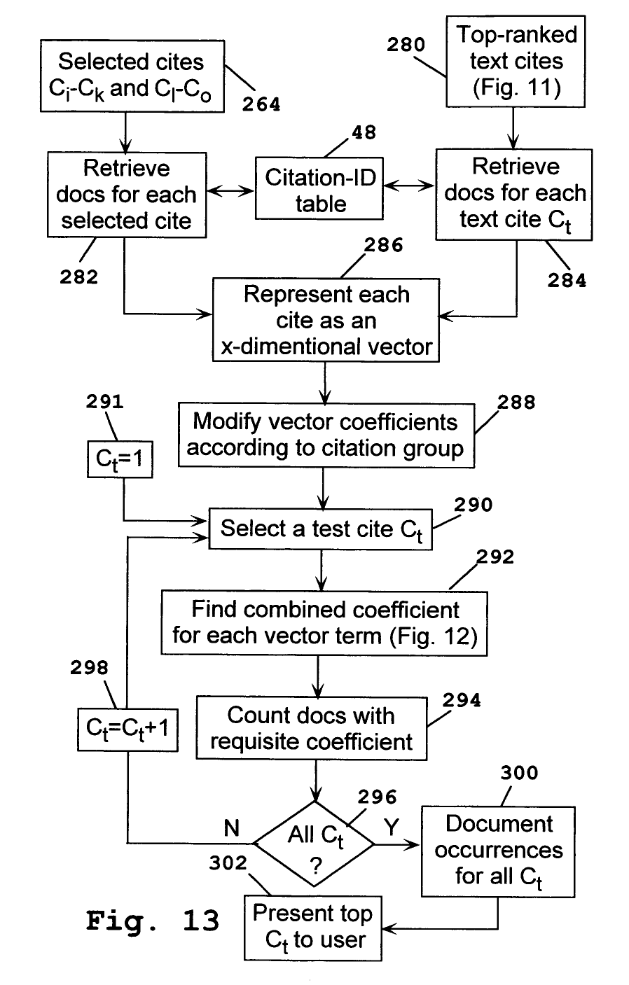

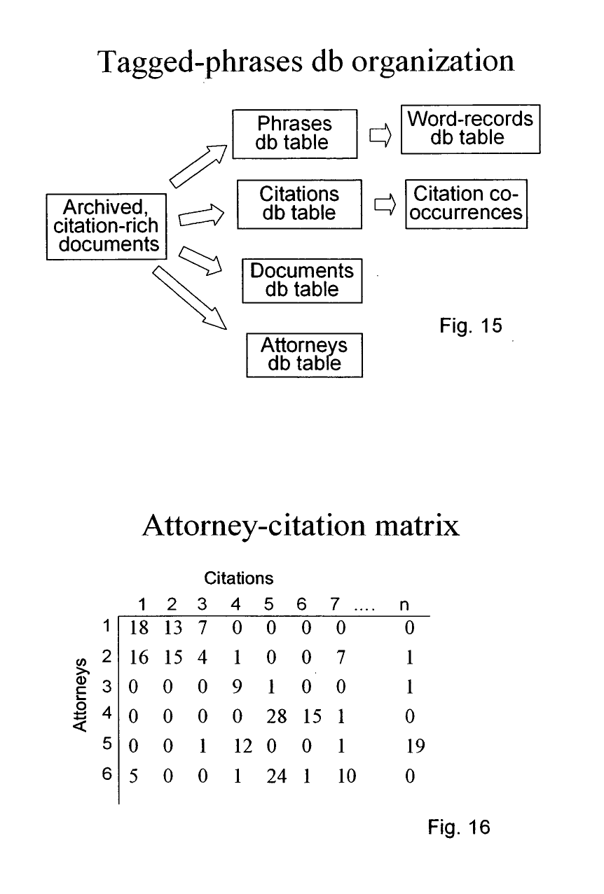

FIGS. 14A-14E illustrate, in Venn-diagram form, how the system-directed search mode of operation functions to assist the user in finding one or a few pertinent documents containing a group of selected propositions or phrases. In the first step (level 1), the user uses a first phrase query to identify one or more related citations, and the program identifies all of those documents containing the citations, indicated by the document subset 1 in FIG. 16A. In a second search step (level 2), the user employs a second phrase query to identify a second group of one or more related citations that ideally (i) represent a substantially different proposition from that of the first query, (ii) are likely to be found in documents of interest, and (iii) are likely to preserve a relatively large number of documents. The search results for this query are shown by the document subset 2 shown in FIG. 16B. The intersection of the two subsets represents those documents containing citations from both of the first two queries.

At any time after the first query, but typically after 2-3 user-directed queries, the user may resort to the system-directed (autosearch) mode to find citations that represent relevant phrases or propositions that the user believes would likely be found in a document of interest and, at the same time, condense the size of the document search space in an orderly way, particularly to avoid having the document search space collapse drastically before additional relevant phrases can be considered. As discussed above, the system-directed mode functions to (i) identify additional citations that are associated with each of the previous citation queries and (ii) let the user-know how many documents are preserved with each of these citations. In the present case, where system direction is used after two user-directed queries, the first iteration of the automated mode will produce a list of citations that overlap with citations from the first two groups, and FIG. 16C shows three of these groups, indicated at 3j, 3k, and 3l. Of these, assume the user selects the largest group cj, which now becomes document subset 3, and then conducts a second iteration of the automated mode to find those pertinent citations that overlap with each of the first three subsets. FIG. 16D shows three of the possible newly generated citations subsets 4j, 4k, and 4l. Assume now that the user selects two of these, 4j, and 4k as the fourth subset, and repeats the search once more. FIG. 16E shows this result, where one of the citation subsets overlaps all four of the previous ones, is presumably relevant, and is selected as the final search query.

It can now be appreciated how citation-based searching, particularly when combined with system-directed searching, allows a user to find one or a small number of citation-rich documents of interest from among a large number, e.g., several hundred thousand of more document in a database. First, the phrase word query is robust in the sense that citations of interest can be retrieved without knowing the exact wording or language contained in the citation. Secondly, with the assumption that every document can be uniquely identified by a relatively small number of phrases or propositions, the user is able to locate this document or a small numbers of related documents by directing queries aimed at these few phrases. To this end, the system can be operated to prompt the user in the selection of additional citations that are both pertinent and still preserve a goodly number of documents. Finally, once a small number of document-defining citations have been identified, the user may easily assess the quality of the search simply by reviewing the citation-related phrases, without having to review the entire document for content.

F2. Issue spotting In effect, the system-directed feature just described acts to generate the logic phrase: if C₁, C₂, . . . Cₑ (already-selected citations), then Cᵢ, Cⱼ, Cₖ, . . . Cₙ (as yet unselected citations), with the document number value for each Cᵢ, Cⱼ, Cₖ, . . . Cₙ indicating a degree of relation to the already identified citations. The same logic phrase can be employed by the user, for example, to identify additional issues or phrases that are associated with already established phrases. In the legal field, this feature would acₜ like an “issue spotting,” in which the system, in possession of a small number of issues (phrases or citation) will generate a list of other issues to be considered.

F3. Word-based searching. It will be appreciated how the method above can be applied to a word-based search system as well, in accordance with yet another aspect of the present invention. In a word-based system, one first generates a word-records table of all words in a a group of documents, e.g., the abstracts in a large group of patents or journal articles. From this table, one then constructs a word co-occurrence matrix whose W×W matrix values represent the co-occurrence of each of the (non-generic) W words in the documents. The system will also include a word index table in which each word includes a table entry consisting of a document string whose N “0” and “1” values would indicate whether that word was absent or present in any of the N given document.

In performing a word-based search, one would, for example, start with a group of word synonyms wᵢ, wⱼ, wₖ, in a first word-based query and a second group of related words wₗ, wₘ, wₙ, wₒ in a second word-based search. It is understood that these initial levels of search could be carried out conventionally using a word index constructed from the documents, as described above with reference to FIG. 7. Once these two initial levels of search are completed, the program would access the word co-occurrence matrix to find those words, e.g., 50-200 words, having the highest co-occurrence with the search terms already selected. These “test” words would, in turn be tested against the document strings for the previously selected words, identical to either of the approaches described above for the citation groups, and the test words then ranked according to the number of documents each test word preserves, when considered with the already-selected query words. The results, e.g., ranked according to document number, are then presented to the user for selection of the next word or group of related words to be employed in a word-based search for a document.

For example, at the first system-directed level of search (the third level in this illustration), the user would be presented with a list of, for example, 5-20 words, and the number of documents each word would preserve, if selected by the user for the next level of searching. This search method is then repeated until a suitably small number of documents are located.

G. Citation-based Knowledge Management System

The present invention also provides a citation-based information- or knowledge-management system based on the phrases/citation database structure detailed above in which phrases provide a robust search format for accessing corresponding citation, and the citations provide well-defined data for database connection to other types of well-defined data in the system, for example, in a KM system for a law firm where citation database connections (relationships) can be made to (i) archived documents, (ii) users, i.e., lawyers, (iii) matters, and (iv) clients.

FIG. 15 illustrates a basic tagged-phrases citation database (db) organization for a law-group KM system, which will be discussed as a representative type of KM system based on a phrases/citation db format. The citations in the db are derived primarily from archived documents prepared by members of the organization, e.g., law-firm lawyers, but might also include available case-law decisions. The documents are processed as described above, to yield database tables for phrases, citations, documents, and attorneys, as discussed above with reference to FIGS. 3 and 4. Also as discussed above, the phrases db table is used to generate a word-records table, and the citation db table is used to generate a citation co-occurrence matrix.

The KM system may also include additional matrices that are related to client or attorney information, as represented by the attorney-citation matrix described with reference to FIG. 16. As seen, this is an A×C matrix of all attorneys A and all citations c₁ where each matrix value represents the number of citations that have appeared in archived documents written by attorney aᵢ. To construct this matrix, each citation in the citation db table is examined to extract the name(s) of the attorney who authored archived documents containing that citation. For each attorney name found, a given value, e.g., 1, is placed in the matrix location corresponding to citation. A matrix value of “0” of course means that attorney aᵢ did not use that citation in any archived document.

To identify attorneys within a firm who have expertise in a given area of law, for example, the user input a query statement expressing the desired legal principle of interest. The program will then return a list of highest-ranked phrases, and citations from which the user can select one of more phrases that most accurately capture the legal principle of interest. The citations associated with the selected phrases become links to attorney data, by accessing the attorney-citation matrix just described. In this case, assuming that the user is seeking an attorney with expertise related to citations 1, 2, and 7 in the table, the program would identify attorney 2 in the matrix as a suitable candidate.

As another example, assume that the user is conducting a patent search in a given area, and that the KM system of interest contains phrases extracted from scientific and technical journals. By inputting a phrase related to the invention, and accessing a author-citation matrix of the type just described, the user can identify a list of authors that should be included in the search.

Thus, the KM system has the ability to enhance in-house performance and expertise by giving in-house users, e.g., attorneys or researchers, access to a citation database, for research purposes, and easy retrieval of archived documents. At the same time, the system can carry out a number of matrix operations based on mined document information.

H. Derivative Tagged Phrases

Given a sufficiently large and diverse collection of citation-rich documents, the phrases extracted from the documents will represent a substantial collection of knowledge in that field. For purposes of the application in this section, the phrases can serve as a basis set of phrases by which a significant portion of ideas in the field can be expressed. Viewed another way, if one were to examine any document in the field, many or most of the sentences making up that document could be mapped, in content, into one or more of the tagged phrases. This mapping, in turn, will give rise to a derivative set of “tagged sentences,” each composed of a non-citation sentence and a non-citation tag assigned to that phrase. The derivative tagged sentences can, in turn, be used like the original tagged phrases to (i) identify document passages of interest, (ii) search for documents, (iii) find document data based on links between derivative phrases and derivative tags, and (iv) navigate between the data tables relating to the original tagged phrases extracted from citation-rich documents and data tables relating to the derivative tagged sentences, using the common citation tags as links between the two sets of tables or data.

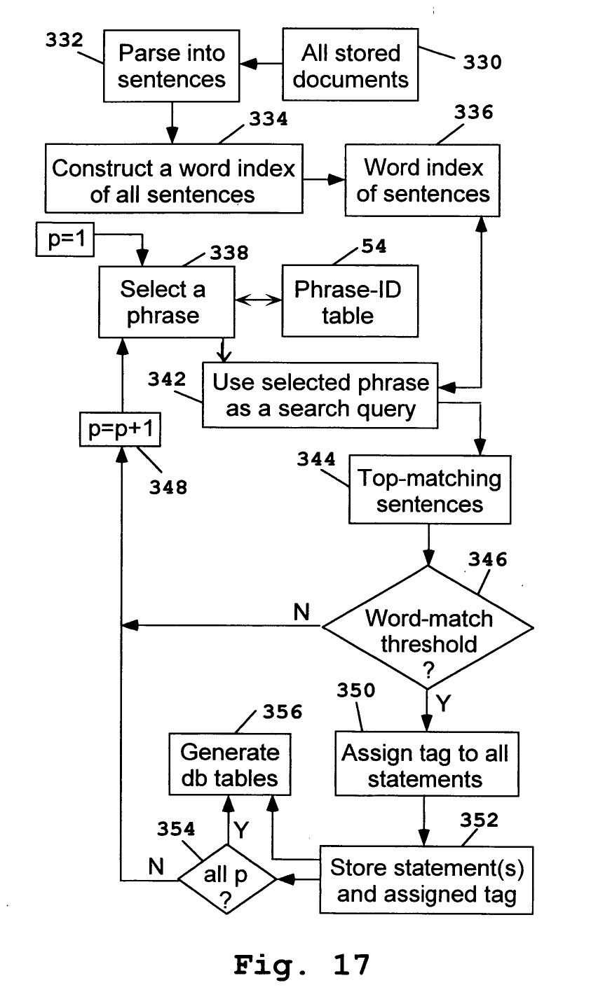

FIG. 17 is a flow diagram of system operation in generating a set of derivative tagged phrases from a collection of documents, indicated at 330. This collection can include, in addition to citation-rich documents, any other stored or archived document within an enterprise, e.g., internal memos, reports, client letters, agreements, and email correspondence. Each document is successively processed to (i) parse the text into sentences (box 332), and (ii) use the extracted sentences to generate (box 334) a word-records or word index table 336. This table is like word index 50 described above, but where each word is associated with a sentence identifier rather than a phrase identifier.

To match the original tagged phrases with the extracted document sentences, a phrase counter is set at p=1 (box 340), indicating the first phrase in phrase-ID table 54. The phrase is then parsed into non-generic words and employed as a search query (box 342), where the search is carried out as described in FIG. 7, but with word index 336 as the target word index. After ranking the retrieved sentences from the search, those sentences that meet a defined match threshold, e.g., greater than 70% word overlap (diamond 346) are assigned a tag at 350. That is, the same tag is assigned to all statements that meet a certain match criterion with the phrase of interest, producing a one-to-many correspondence between each original phrase and word-matched sentences extracted from the documents, and a one-to-one correspondence between each original tag and each newly-assigned tag. As indicated, those sentences that do not meet the required word-match threshold are simply ignored. Some of these sentences will, of course, be later associated with other phrases from table 54. The statements and assigned tag are stored at 352. This process is repeated, through the logic 354, 348, until each phrase has been mapped onto one or more sentences from the stored documents.

The stored sentences and tags (derivative tagged phrases) are now used to generate the same types of database tables described above for the actual tagged phrases. For example, a sentence-ID table may be used to identify sentences or passages contained in the stored documents. Individual stored documents can be retrieved by a multi-level search of the type described above, where any document can be characterized as having some unique group of sentences with distinguishable content. Since the search query used in for accessing data in the derivative tagged phrases will depend on word match with the extracted sentences, not the original phrases used to identify those sentences, the ability to locate closely matched sentences is preserved.

More general, the invention includes, in one aspect, a method of constructing a tagged statements database for stored documents in a given field, such as a legal, technical, or enterprise field, where enterprise field can include, for example, all or some subset of documents within an enterprise, such as a corporation. The method follows the steps described with respect to FIG. 17, where the database of tables generated include (i) a searchable word index of the tagged sentences, (ii) a table relating sentence ID to tag ID and (iii) one or more tables relating tag ID to other data in the documents.

The derivative tagged phrases can provide many of the search and knowledge-management functions described above for citation phrase extracted from citation-rich documents. In addition, since the tags in the derivative tagged phrases will have a one-to-one correspondence with the citation tags in the original tagged phrases, a user can navigate easily between the two tagged-phrase database sets. For example, a user could find a sentence of interest in a document, and use the associated tag to identify citations or other phrases associated with that tag in the database tables for original tagged phrases.

I. User Interface

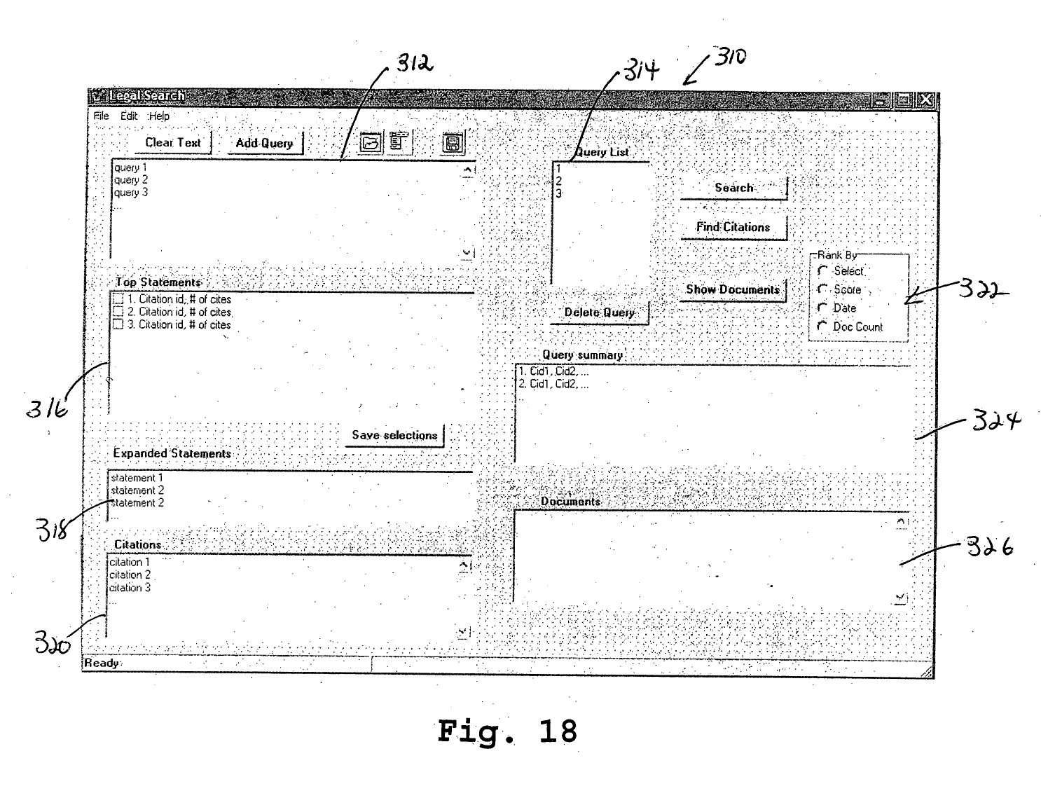

FIG. 18 shows a graphical interface in the system of the invention for use in citation and document searching. The interface includes a query box 312 in which the user enters a statement query, e.g., a sentence or sentence fragment or key words of a phrase corresponding to a citation of interest. Once this query is entered, the user clicks on the “Add Query” button, signaling the program to identify the non-generic query words, and construct the appropriate search vector. This query is identified as the first query in the query list at 314. To start the search, the user clicks on the “Search” button, which initiates the phrase word-match search described above with respect to FIG. 7.

When this initial phrase search is completed, the top-match phrases are displayed in phrase box 316, which also shows the citation ID for each phrase. By clicking on a citation in box 316, the program will show all of the phrases for that citation in box 318 for “Expanded Phrase”. By clicking on a cite ID in box 316, the program will also show the full citation data in box 320. As discussed above, the phrases and citations shown in box 316 can be ranked and displayed by Match Score, Citation Date, and Document Count, using the radial buttons at 322. The top “Select” button in this group is used to select one or more citations in a query (search stage).

At this point, the user may initiate another round of searching, by entering a new query, and repeating the steps of evaluating and selecting one or more “second-stage” citations. At any time during the search, the user may switch to a system-directed mode by clicking on the “Find Citations” button, which initiates the program operations of (i) finding test citations that have high co-occurrence with the citations already selected by the user, and (ii) determining the number of documents containing at least one citation in each of the already selected groups and the test citation, and (iii) presenting these to the user, e.g., ranked by total number of document.

At the completion of the search, which can include both user-directed and system-directed modes, the user can request a query summary, in box 324, which displays, for each query number form box 314, the citations selected in that query. The user can also request, for any query, a summary of documents containing that query and all previous queries. The document information, including document ID, date, author, selected citations, and corresponding phrase is presented in box 326. It will be appreciated that all of the interface text boxes may switch to a scroll-down mode when they contain more text than the display panel can handle.

The following example illustrates, but in no way is intended to limit, certain methods of the invention.

### EXAMPLE

### Word Query Searches for Phrases and Citations

Approximately 1,000 recent decisions from the Court of Appeals for the Federal Circuit (CAFC) involving questions of patent law were processed to extract all citations and associated phrases. The extracted phrases and citations were assembled into a database having a word index table, a phrase-ID table, and a citations-ID as described above.

A. Citation search 1: The statement query in a first search was: “claims are interpreted on the basis of intrinsic evidence, that is, the claim language, the written description, and the prosecution history.”

The program was set to display the top 15 phrase word matches. As a sample of the quality of word matches, the retrieved phrases that were ranked 1, 4, 7, 10, and 13 are presented below, along with the associated citation and the number of documents containing that citation:

1. “the words used in the claim[ ] are interpreted in light of the intrinsic evidence of record, including the written description, the drawings, and the prosecution history, if in evidence.” teleflex, inc. v. ficosa n. am. corp., 299 f.3d 1313, 211 f.3d 1367. 53 docs contain this cite.

4. “in determining the meaning of disputed claim language, we look first to the intrinsic evidence of record, examining the claim language itself, the specification, and the prosecution history.” interactive gift express, inc. v. compuserve, inc., 256 f.3d 1323. 31 docs contain this cite.

7. “as a basic principle of claim interpretation, prosecution disclaimer promotes the public notice function of the intrinsic evidence and protects the public's reliance on definitive statements made during prosecution.” digital biometrics v. identix, inc., 149 f.3d 1335. 8 docs contain this cite.

10. “indeed, claims are not construed in a vacuum, but rather in the context of the intrinsic evidence, viz., the other claims, the specification, and the prosecution history.” demarini sports, inc. v. worth, 239 f.3d 1314.13 docs contain this cite.

13. “as a basic principle of claim interpretation, prosecution disclaimer promotes the public notice function of the intrinsic evidence and protects the public's reliance on definitive statements made during prosecution.” omega eng'g, inc. v. raytek corp., 334 f.3d 1314. 32 docs contain this cite.

As seen, each of the phrases from the documents, at least down through the 13^{th} ranked phrase, shows a good content match with the user query. For each citation, the total number of phrases associated with that citation was typically equal to the number of documents containing that cite. Thus, for example, in the citation for the 10^{th}-ranked phrase: digital biometrics v. identix, inc., 149 f.3d 1335. a total of eight documents contained this citation. The eight phrases associated with this citation were:

1. as a basic principle of claim interpretation, prosecution disclaimer promotes the public notice function of the intrinsic evidence and protects the public's reliance on definitive statements made during prosecution.

2. as a basic principle of claim interpretation, prosecution disclaimer promotes the public notice function of the intrinsic evidence and protects the public's reliance on definitive statements made during prosecution.

3. a disclaimer must be clear and unambiguous.

4. statements that describe the invention as a whole, rather than statements that describe only preferred embodiments, are more likely to support a limiting definition of a claim term.

5. id.

6. and therefore consideration of extrinsic evidence is inappropriate.

7. such as expert testimony and treatises, is improper.

8. when the court relies on extrinsic evidence to assist with claim construction, and the claim is susceptible to both a broader and a narrower meaning, the narrower meaning should be chosen if it is supported by the intrinsic evidence.

This sample of phrases illustrates the type and variation of phrases that might be expected for a given citation tag.

A. Citation search 2: The statement query in a second search was: “whether the doctrine of equivalents can be used to recapture claim scope surrendered during patent acquisition is a question of law.”

As above, the program was set to display the top 15 phrase word matches, and the phrases that were ranked 1, 3, 7, 10, and 13 are displayed, including the corresponding citation and number of documents containing that citation:

1. “application of the rule precluding use of the doctrine of equivalents to recapture claim scope surrendered during patent acquisition is a question of law.” kcj corp. v. kinetic concepts, inc., 223 f.3d 1351. 5 docs contain this cite.

3. “application of prosecution history estoppel to limit the doctrine of equivalents presents a question of law that this court reviews without deference.” glaxo wellcome, inc. v. impax labs., inc., 356 f.3d 1348. 3 docs contain this cite.

7. “prosecution history estoppel as a limit on the doctrine of equivalents presents a question of law.” wang labs., inc. v. Mitsubishi elecs. am., inc., 103 f.3d 1571. 4 docs contain this cite.

10. “a patent applicant may limit the scope of any equivalents of the invention by statements in the specification that disclaim coverage of subject matter.” j m corp. v. harley-davidson, inc., 269 f.3d 1360. 3 docs contain this cite.

13. “the district court's determination that chicago brand's complaint was barred under ninth circuit law by the doctrine of res judicata is a mixed question of law and fact, wherein legal issues predominate.” gregory v. widnall, 153 f.3d. 071.1 doc contains this cite.

As can be seen, content match with the user query dropped off significantly between the 7^{th} and 10^{th} ranked phrases, indicating a more limited number of citations that contain the phrase of interest.

The 1^{st} ranked citation, kcj corp. v. kinetic concepts, inc., 223 f.3d 1351, was found in five documents, and was associated with a total of five phrases. These phrases, given below, further illustrate the type and variation in phrases that can be expected for a given citation.

1. “application of the rule precluding use of the doctrine of equivalents to recapture claim scope surrendered during patent acquisition is a question of law.”

2. “creates a presumption that the recited elements are only a part of the device, that the claim does not exclude additional, unrecited elements.”

3. “in open-ended claims containing the transitional phrase “comprising.”

4. “asserted claims 1 and 6 recite a list of lewis acid inhibitors presented in the form of a markush group.”

5. “such references are not enough to limit the claims to a unitary structure.

While the invention has been described with respect to particular embodiments and applications, it will be appreciated that various changes and modification may be made without departing from the spirit of the invention.

It is claimed:

1. A computer-assisted method for use in accessing information derivable from a collection of citation-rich documents, such as scientific articles, works of scholarship, legal appellate cases, legal documents, and the like, comprising
(a) accessing a database containing phrases that represent summary holdings, statements, or conclusions contained in said documents, and for each such phrase, a tag representing the citation associated with that statement in a document,
(b) searching said database to identify one or more phrases that correspond to a user-input statement of interest,
(c) accessing the database to link each of the one or more phrases identified in (b) to an associated citation tag in said database, and
(d) presenting to the user, information related to the linked citation tag(s) from step (c).

2. The method of claim 1, for use in identifying one or more citations for a user-input statement of interest, wherein the information presented to the user in step (d) includes (i) the one or more phrases identified in step (b) and (ii) for each phrase, the citation corresponding to the tag associated with that phrase.

3. The method of claim 2, wherein at least some of the citations in the database are associated with multiple phrases, and the information presented in step (d) further includes for each citation presented, phrases associated with that citation other than those identified in step (b).

4. The method of claim 1, wherein said database includes a words-record table or index containing non-generic words in said phrases, and for each word in the table, a list of all phrases, by phrase identifier, that contain that word, and, in the same or in a separate table, a citation identifier associated with each phrase identifier,
said searching step (b) includes, for each non-generic word in said word user-input statement, accessing the word-records table to identify all phrases in the documents containing that word, and determining the phrase(s) in said database having the highest word match ranking with said statement, and
said linking step (c) includes accessing a table in said database to determine the identifiers of the citations associated with the highest-ranking phrase(s).

5. The method of claim 1, for use in identifying one or more documents whose content is related to a user-input statement of interest, wherein said database includes a table linking each citation with one or more documents, and the information presented in step (d) includes information about the documents containing the one or more citations linked from step (c).

6. The method of claim 5, which further includes repeating step (b)-(d) for each of one or more additional user-input statements of interest, and the information presented in step (d) at each iteration includes information about the documents that contain citations relating to the successive user-input statements.

7. The method of claim 5, which further includes, following step (d) in each iteration, accepting user input indicating a selection of one or more presented citations for that iteration.

8. The method of claim 7, wherein at each iteration, there is displayed along with the citations, the number of documents containing the previously selected and newly selected citations, where the iterations are continued until the number of, documents containing the selected and identified citations is desirably small.

9. The method of claim 8, wherein said database includes a matrix whose matrix values represent, for each pair of citation tags, a number related to the document affinity of the two citations of the pair, and which further includes the step (e), after selecting one or more citations identified from more or more iterations of steps (b)-(d), (e1) accessing said matrix to identify citations that have a high affinity with the one or more selected citations, (e2) determining for each of the citations identified in (e1), the total number of documents containing one or more of the selected citations and one of said citations identified in (e1), (e3) displaying those citations identified from (e1) having the highest total number of documents determined from (e2), along with the document number so determined, and (e4) allowing the user to select one or more citations displayed in (e3).

10. The method of claim 1, for use in accessing data derivable from said citation-rich documents, wherein said database includes one or more tables relating said citation tags to said data, and the information displayed in step (d) includes the data of interest.

11. The method of claim 10, wherein the data presented in step (d) is related to one or more from the groups consisting of document date, document author, citation author, citation date, and other citation tags related to the linked citation tag from step (c).

12. Computer-readable code for use with an electronic computer in accessing information derivable from a collection of citation-rich documents, such as scientific articles, works of scholarship, appellate cases, legal documents, and the like, by accessing a database containing phrases that represent summary holdings, statements, or conclusions contained in said documents, and for each such phrase, a tag representing the citation associated with that statement in a document, wherein said code is operable, under the control of said computer, and by accessing said database, to perform the steps of claim 1.

13. An information retrieval system for use in accessing information derivable from a collection of citation-rich documents, such as scientific articles, works of scholarship, appellate cases, legal documents, and the like, comprising
(1) a computer
(2) accessible by said computer, a database containing phrases that represent summary holdings, statements, or conclusions contained in said documents, and for each such phrase, a tag representing the citation associated with that statement in a document,
(3) a user input device operatively connected to said computer, by which the user can input one or more statements of interest,
(4) computer-readable code which operates on said computer to perform the steps of claim 1, and
(5) a display device operatively connected to the computer for presenting to the user, information produced in carrying out the steps of claim 1.

14. A citation statements database for citation-rich documents, such as scientific articles, works of scholarship, appellate cases, legal documents and the like containing phrases that represent summary holdings or conclusions of references cited in the documents, comprising
(1) a words-record table or index containing non-generic words in said phrases, and for each word in the table, a list of all phrases, by phrase identifier, that contain that word, and, in the same or in a separate database table,
(2) a phrase-identifier table of all phrase identifiers, and, for each phrase identifier in the table, the text of that phrase, and the tag identifier of the citation associated with that phrase in said documents, and
(3) a tag-identifier table of all citation tag identifiers, and for each tag identifier, a list of all documents containing the corresponding citation.

15. The database of claim 14, which further includes a document-identifier table of all document identifiers, and for each such identifier, information relating to that document.

16. The database of claim 14, which further includes an affinity matrix whose matrix values represent, for each pair of citations in the database, the affinity between each pair of citations in said documents.
